(19) United States
(12) Patent Application Publication
(10) Pub. No.: US 2025/0030617 A1
(43) Pub. Date: Jan. 23, 2025

(54) SYSTEMS AND METHODS FOR LOGGED QUALITY OF EXPERIENCE MEASUREMENT

(71) Applicant: ZTE Corporation, Shenzhen (CN)

(72) Inventors: Yansheng LIU, Shenzhen (CN); Yin GAO, Shenzhen (CN); Dapeng LI, Shenzhen (CN); Man ZHANG, Shenzhen (CN)

(73) Assignee: ZTE Corporation, Shenzhen (CN)

(21) Appl. No.: 18/737,610

(22) Filed: Jun. 7, 2024

Related U.S. Application Data
(63) Continuation of application No. PCT/CN2022/098757, filed on Jun. 14, 2022.

(51) Int. Cl. H04L 41/5067; H04W 76/27

(52) U.S. Cl. CPC H04L 41/5067; H04W 76/27

(57) ABSTRACT

Presented are systems and methods for logged Quality of Experience (QoE) measurement. A wireless communication device (e.g., a UE) may store a measurement of QoE as QoE buffered data. The wireless communication device may send a first message including the QoE buffered data to a wireless communication node (e.g., a BS).

### CROSS-REFERENCE TO RELATED APPLICATION

This application claims the benefit of priority under 35 U.S.C. § 120 as a continuation of International Patent Application No. PCT/CN2022/098757, filed on Jun. 14, 2022, the disclosure of which is incorporated herein by reference in its entirety.

### TECHNICAL FIELD

The disclosure relates generally to wireless communications, including but not limited to systems and methods for logged quality of experience (QoE) measurement.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium of the following. A wireless communication device (e.g., a UE) may store a measurement of Quality of Experience (QoE) as QoE buffered data. The wireless communication device may send a first message including the QoE buffered data to a wireless communication node (e.g., a BS).

In some embodiments, the wireless communication device may store the QoE buffered data when the wireless communication device is not in an RRC_CONNECTED state. The wireless communication device may send the first message before the wireless communication device switches back into the RRC_CONNECTED state.

In some embodiments, the wireless communication device may receive a second message (e.g., RRC release message), causing the wireless communication device to switch from an RRC_CONNECTED state to an RRC_INACTIVE state or an RRC_IDLE state, from the wireless communication node. Prior to receiving the second message, the wireless communication device may receive a third message indicating that the wireless communication device can trigger the measurement of QoE in any of the RRC_CONNECTED state, the RRC_INACTIVE state, or the RRC_IDLE state. After switching into the RRC_INACTIVE state or the RRC_IDLE state, the wireless communication device may continue storing the measurement of QoE as the QoE buffered data. In some embodiments, prior to receiving the second message, the wireless communication device may receive a fourth message indicating that the wireless communication device can only trigger the measurement of QoE in the RRC_INACTIVE state or the RRC_IDLE state. After switching into the RRC_INACTIVE state or the RRC_IDLE state, the wireless communication device may store the measurement of QoE as the QoE buffered data.

In some embodiments, the wireless communication device may receive a fifth message (e.g., RRC resume message, RRC setup message), causing the wireless communication device to switch back into the RRC_CONNECTED state, from the wireless communication node. The wireless communication device may send a sixth message (e.g., RRC resume complete message, RRC setup complete message) including QoE buffer information, in response to receiving the fifth message, to the wireless communication node. The QoE buffer information of the sixth message may include at least one of: a 1-bit indicator indicating that a buffer of the wireless communication device may not be empty; QoE session information; a number of QoE reports; a QoE report size for one QoE session; data on other QoE parameters related data; or a size of the buffer.

In some embodiments, following sending the sixth message, the wireless communication device may switch itself to the RRC_CONNECTED state. The wireless communication device may receive a seventh message (e.g., RRC message 2, RRC reconfiguration message) including QoE requirement information from the wireless communication node. The QoE requirement information may include at least one of: an APP layer identifier (ID); QoE buffer information; or a QoE reference ID. In response to receiving the seventh message, the wireless communication device may send an eighth message (e.g., RRC message 3) including acknowledgement information to the wireless communication node.

In some embodiments, a wireless communication node (e.g., a BS) may receive a first message including Quality of Experience (QoE) buffered data from a wireless communication device (e.g., a UE). The QoE buffered data may be stored by the wireless communication device.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure.

FIG. 2 illustrates a block diagram of an example base station and a user equipment device, in accordance with some embodiments of the present disclosure.

FIG. 3 is a sequence diagram illustrating logged quality of experience (QoE) measurement, in accordance with an embodiment of the present disclosure.

FIG. 4 is a sequence diagram illustrating logged quality of experience (QoE) measurement, in accordance with an embodiment of the present disclosure.

FIG. 5 is a sequence diagram illustrating logged quality of experience (QoE) measurement, in accordance with an embodiment of the present disclosure.

FIG. 6 is a sequence diagram illustrating logged quality of experience (QoE) measurement, in accordance with an embodiment of the present disclosure.

FIG. 7 is a sequence diagram illustrating logged quality of experience (QoE) measurement, in accordance with an embodiment of the present disclosure.

FIG. 8 is a sequence diagram illustrating logged quality of experience (QoE) measurement, in accordance with an embodiment of the present disclosure.

FIG. 9 is a sequence diagram illustrating logged quality of experience (QoE) measurement, in accordance with an embodiment of the present disclosure.

FIG. 10 is a sequence diagram illustrating logged quality of experience (QoE) measurement, in accordance with an embodiment of the present disclosure.

FIG. 11 is a sequence diagram illustrating logged quality of experience (QoE) measurement, in accordance with an embodiment of the present disclosure.

FIG. 12 is a sequence diagram illustrating logged quality of experience (QoE) measurement, in accordance with an embodiment of the present disclosure.

FIG. 13 is a sequence diagram illustrating logged quality of experience (QoE) measurement, in accordance with an embodiment of the present disclosure.

FIG. 14 is a sequence diagram illustrating logged quality of experience (QoE) measurement, in accordance with an embodiment of the present disclosure.

FIG. 15 is a sequence diagram illustrating logged quality of experience (QoE) measurement, in accordance with an embodiment of the present disclosure.

FIG. 16 is a sequence diagram illustrating logged quality of experience (QoE) measurement, in accordance with an embodiment of the present disclosure.

FIG. 17 is a sequence diagram illustrating logged quality of experience (QoE) measurement, in accordance with an embodiment of the present disclosure.

FIG. 18 is a sequence diagram illustrating logged quality of experience (QoE) measurement, in accordance with an embodiment of the present disclosure.

FIG. 19 illustrates a flow diagram of an example method for logged quality of experience (QoE) measurement, in accordance with an embodiment of the present disclosure.

### DETAILED DESCRIPTION

### 1. Mobile Communication Technology and Environment

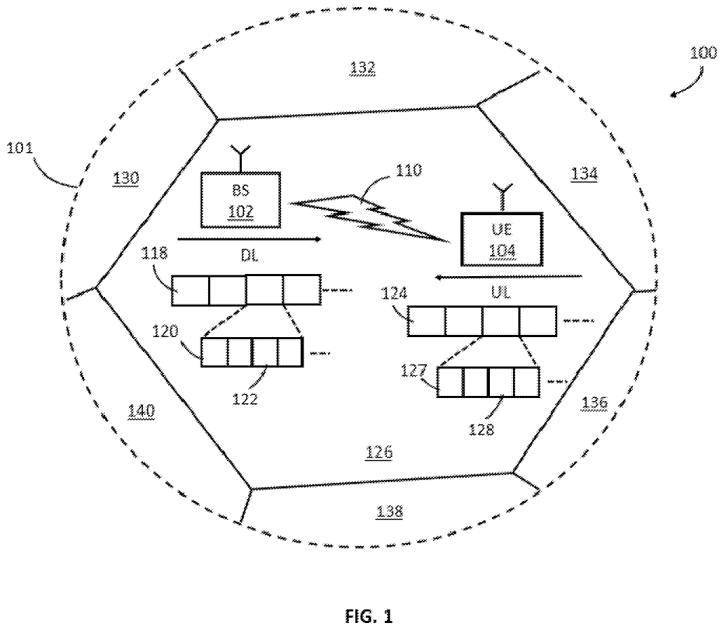

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

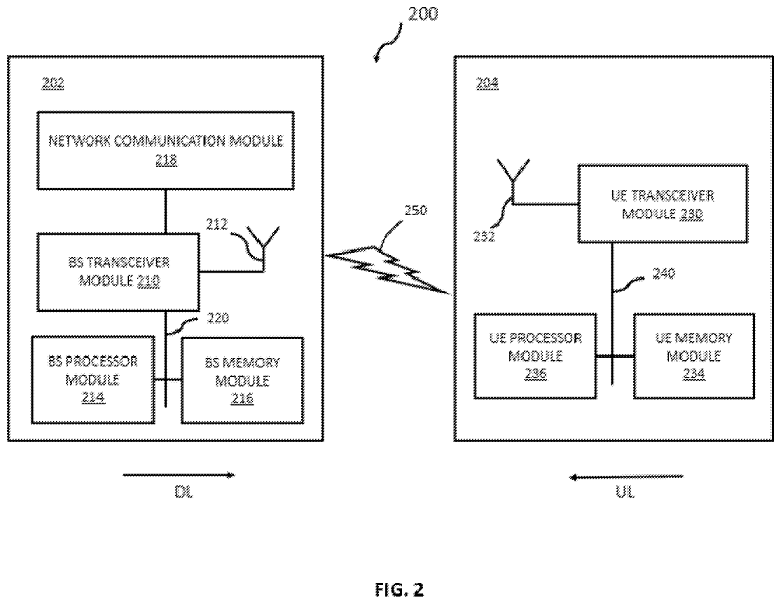

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Logged Quality of Experience (QoE) Measurement

INACTIVE/IDLE logged Quality of Experience (QoE) can be supported. When a user equipment (UE) is in an RRC_CONNECTED state, the QoE may be activated and collect data. With supporting of a new QoE service type (e.g., multicast and broadcast service (MBS)), companies may believe the QoE can be necessary to be performed in any RRC state (e.g., RRC_IDLE, RRC_CONNECTED, or RRC_INACTIVE) in some cases. In the present disclosure, a new kind of QoE (e.g., logged QoE) is introduced. The logged QoE can perform in a non-CONNECTED state in some cases. The configurations and reporting of the logged QoE are discussed as follows. Based on Rel-17, multicast service can only perform in an RRC_CONNECTED state. However, a UE can use broadcast service in any RRC state. Multicast and broadcast service (MBS) can be introduced as a new service type in QoE in Rel-18. New radio (NR) QoE is also introduced in Rel-17. The NR QoE can only perform QoE measurements when a UE is in RRC_CONNECTED. Network (NW) may configure the QoE for a specific application to a UE when the UE is in RRC_CONNECTED. When the UE starts the application, the QoE can be activated and start to measure QoE data.

A logged QoE can be performed in either a CONNECTED state (e.g., RRC_CONNECTED) or a Non-CONNECTED state (e.g., RRC_INACTIVE, RRC_IDLE) in some of following implementation examples. Network may use one of the following combinations (e.g., a service type, a state indicator, or sub service types) to distinguish the Non-CONNECTED logged QoE with CONNECTED logged QoE.

In some embodiments, a service type can be MBS, Broadcast, or Multicast. A state indicator can be non-CONNECTED mode logged QoE (e.g., non-CONNECTED). When a logged QoE configuration indicates that the service type is MBS and the state indicator is non-CONNECTED, a logged QoE can be only performed in a non-CONNECTED state. When a logged QoE configuration only indicates that the service type is MBS, a logged QoE can be only performed in a CONNECTED state.

In some embodiments, a service type can be MBS, Broadcast, or Multicast. A state indicator can be CONNECTED mode logged QoE (e.g., CONNECTED). When a logged QoE configuration indicates that the service type is MBS and the state indicator is CONNECTED, a logged QoE can be performed in a CONNECTED state. When a logged QoE configuration only indicates that the service type is MBS, a logged QoE can be only performed in a non-CONNECTED state. A service type (e.g., MBS, Broadcast, or Multicast) with non-CONNECTED indicator may indicate the UE can perform/trigger a logged QoE measurement in a non-CONNECTED state. A service type (e.g., MBS, Broadcast, or Multicast) without non-CONNECTED indicator may indicate the UE cannot perform a logged QoE in a non-CONNECTED state. A service type (e.g., MBS, Broadcast, or Multicast) with CONNECTED indicator may indicate the UE can perform a QoE measuring and can trigger a QoE reporting in a CONNECTED state. A service type (e.g., MBS, Broadcast, or Multicast) without CONNECTED indicator may indicate the UE can perform a QoE measuring and can trigger a QoE reporting in a non-CONNECTED state. A service type (e.g., MBS, Broadcast, or Multicast) with/without any RRC state indicator may indicate the UE can perform a QoE measuring and can trigger a QoE reporting regardless of RRC state. If the network configures the service type (e.g., broadcast) without indicator, the QoE can perform a QoE measuring and can trigger a QoE reporting in a non-CONNECTED state. If the network configures the service type (e.g., broadcast) with an indicator which allows non-CONNECTED state QoE flag, the QoE can perform a QoE measuring and can trigger a QoE reporting in a non-CONNECTED state. If the indicator does not allow CONNECTED state QoE flag, the QoE with the service type as broadcast can perform a QoE measuring and can trigger a QoE reporting in a CONNECTED state.

A sub-service type can be Broadcast (BC), or Multicast (MC). In this alternative, instead of using a service type and a state indicator, the network can use different sub-service type to distinguish a suitable working state. The Broadcast logged QoE can be performed in any RRC state. The Multicast logged QoE can be performed in a CONNECTED state. A sub-service type (e.g., Broadcast or Multicast) without an indicator may indicate the UE can perform a multicast related logged QoE measuring and can trigger QoE reporting in a CONNECTED state. A sub-service type (e.g., Broadcast or Multicast) without an indicator may indicate the UE can perform a broadcast related logged QoE measuring and can trigger QoE reporting in any RRC state.

The terms (e.g., MBS and state indicator) used above may not indicate that a protocol needs to use exactly the same words. For example, the protocol may use Multicast and Broadcast Service instead of MBS or use indicator instead of a state indicator. The following implementation examples may use a service type (MBS) and a state indicator (non-CONNECTED indicator) to illustrate how to configure either a CONNECTED logged QoE or to configure a non-CONNECTED logged QoE. Other alternatives shown above can use a similar procedure for configuration.

For non-CONNECTED logged QoE, performing in non-CONNECTED states (e.g., RRC_INACTIVE or RRC_IDLE) can be explained as follows. A logged QoE can be activated in non-CONNECTED states. In some embodiments, when a UE switches to RRC_CONNECTED, all non-CONNECTED logged QoE may be stopped. In some embodiments, when a UE switches to RRC_CONNECTED, the un-inactivated QoE may not be activated anymore. In spite of that, the ongoing non-CONNECTED logged QoE may be continued until session ends or be modified by the network (e.g., overwrite, full config). In some embodiments, the UE can trigger a QoE reporting in either an RRC_INACTIVE state or an RRC_IDLE state. The real QoE reporting can be performed when the UE is in an RRC_CONNECTED state. In certain embodiments, the UE may not upload QoE report to the network when the UE keeps in an RRC_INACTIVE state or an RRC_IDLE state.

In addition, a definition of Short IP information can be also used in several implementation examples in the disclosure. The Short IP information can be a kind of mark which may be used to let a UE know/notified a destination of generated logged QoE reports. The Short IP information may be a bit string or a number. The information on mapping relationship between the Short IP information and the real IP address may be configured to related NG-RAN nodes by operations, administration and maintenance (OAM) before the logged QoE configuration. The NG-RAN node may keep the mapping relationship locally. A more vivid example can be used to explain the Short IP information, real IP address, and information about mapping relationship.

Table 1 shows an example mapping relationship between Short IP information and real IP address (bit string).

TABLE 1

| Short IP Info | IP address |
|---|---|
| “ . . . 01” | 192.168.0.1 |
| “ . . . 10” | 192.168.0.2 |
| . . . | . . . |

Table 1 shows an example mapping relationship between Short IP information and real IP address (number).

TABLE 2

| Short IP Info | IP address |
|---|---|
| Integer: 1 | 192.168.1.1 |
| Float: 123 | 192.168.1.2 |
| . . . | . . . |

### Implementation Example 1-Logged QoE Configured with Non-CONNECTED Indicator (Non-CONNECTED Logged QoE)

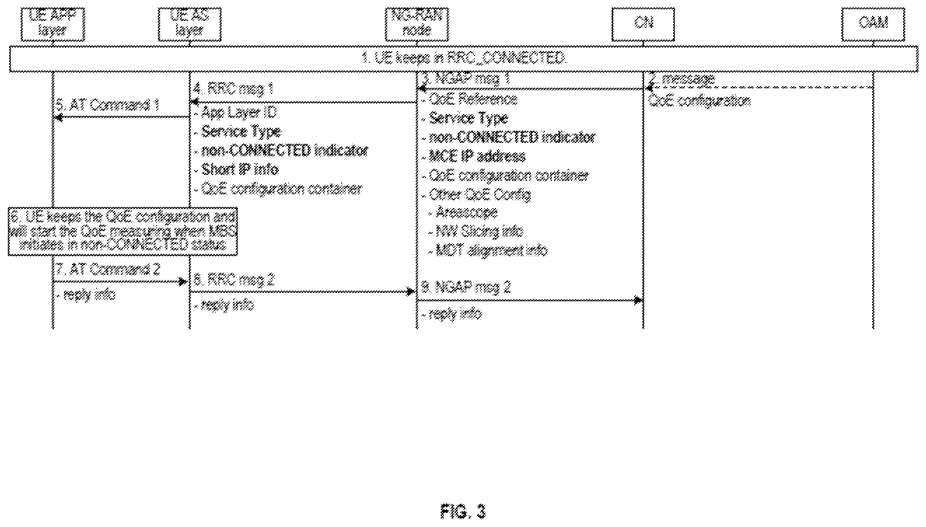

FIG. 3 is a sequence diagram illustrating a procedure for a logged QoE, in accordance with some embodiments. The procedure may be perform by a UE application (APP) layer, a UE access stratum (AS) layer, a next generation radio access network (NG-RAN) node, a core network (CN), and an operations and maintenance (OAM). It is noted that the procedure is merely an example, and is not intended to limit the present disclosure. Accordingly, it is understood that additional operations (e.g., blocks) may be provided before, during, and after the procedure of FIG. 3, certain operations may be omitted, certain operations may be performed concurrently with other operations, and that some other operations may be briefly described herein.

In step 1, a UE may be in an RRC_CONNECTED state before a logged QoE configuration. The logged QoE configuration may trigger a QoE reporting behavior in any RRC status/state. The UE can transmit QoE reports to the network when the UE enters RRC_CONNECTED state.

In step 2, an OAM may send the logged QoE configuration to a CN by a no standardization message.

In step 3, the CN may send a NG application protocol (AP) message 1 to a NG-RAN node within the logged QoE configuration message. The NGAP message 1 may include at least one of the following information: a QoE reference; a service type; a state indicator (non-CONNECTED indicator); a Measurement Collector Entity (MCE) IP address; or a QoE configuration container. The QoE reference ID can be configured by the OAM. The QoE reference ID may be used/utilized/applied to mark the logged QoE in some steps. The service type can be MBS, broadcast, or multicast. In this implementation example, the service type can be MBS. The service type can also be broadcast or multicast in some alternative examples. The state indicator can be non-CONNECTED indicator. The non-CONNECTED indicator may indicate that a logged QoE measurement can be performed/triggered when the UE is in both RRC_IDLE state and RRC_INACTIVE state. In some embodiments, when the logged QoE generates QoE measurement data, the data may be forwarded to the MCE IP address. The QoE configuration container may contain/include a full logged QoE configuration. The other QoE configuration parameters contained/included in step 3 of the procedure/call flow may be discussed in other implementation examples.

In step 4, after the NG-RAN node receives the logged QoE configuration from the CN, the NG-RAN may send a RRC message 1 to a UE. The RRC message 1 may include at least one of the following information: an application (APP) layer identifier (ID); a service type; a state indicator (non-CONNECTED indicator); a QoE configuration container; or Short IP information. A RRC level ID may be used/utilized/applied to mark the logged QoE. In this implementation example, the service type can be MBS. The service type can also be broadcast or multicast in some alternative examples. The state indicator can be non-CONNECTED indicator. The non-CONNECTED indicator may indicate that the logged QoE measurement can be performed/triggered when the UE is in both RRC_IDLE state and RRC_INACTIVE state. The Short IP information may be used/utilized/applied by the NG-RAN to retrieve the real IP address of the MCE. In some embodiments, the Short IP information may also be used as a state indicator (non-CONNECTED indicator). When the UE receives the service type and the short IP information, the UE may know/notice/be aware the logged QoE can be only performed in non-CONENCTED state. In such case, the state indicator (non-CONNECTED indicator) may be omitted in the RRC configuration message. The QoE configuration container may contain/include a full logged QoE configuration. For the short IP information used as a state indicator, the QoE configuration in step 4 may contain/include at least one of the following information: a QoE reference, a service type, a short IP information, or a QoE configuration container.

In step 5, the UE may receive the QoE configuration. The UE AS layer may send the received QoE configuration to the UE APP layer via an ATtention (AT) command. The AT command can be used for controlling mobile termination (MT) functions and global system for mobiles (GSM)/universal mobile telecommunication system (UMTS) network services from a terminal equipment (TE) through terminal adaptor (TA).

In step 6, the UE may keep the QoE configuration and may start the logged QoE measuring when multicast and broadcast service (MBS) initiates in either RRC_IDLE or RRC_INACTIVE state.

In step 7, the UE APP layer may reply messages (e.g., AT command 2) for the AT command. In step 8, the UE AS layer may reply messages (e.g., RRC message 2) for the RRC message. In step 9, the NG-RAN node may reply messages (e.g., NGAP message 2) for the NGAP message. In some embodiments, acknowledge (ACK) information can be used to indicate that the previous message is received successfully. The ACK information may be contained in the messages. The ACK information may be null (e.g., no related information) or an indicator (e.g., indicating everything works normally).

Table 3 shows key points for step 3 with the service type and non-CONNECTED indicator.

TABLE 3

| | | | IE type and | |
|---|---|---|---|---|
| IE/Group Name | Presence | Range | reference | Semantics description |
| QoE Reference | M | | OCTET STRING | QoE Reference may comprise |
| | | | (SIZE(6)) | mobile country code (MCC), |
| | | | | mobile network code (MNC), |
| | | | | and QoE measurement |
| | | | | collection (QMC) ID. The |
| | | | | MCC and MNC can be with |
| | | | | trace activation request from |
| | | | | a management system to |
| | | | | identify one public land |
| | | | | mobile network (PLMN) |
| | | | | containing the management |
| | | | | system. The QMC ID can be |
| | | | | a 3-bytes Octet String. |
| Service Type | M | | ENUMERATED | This information element (IE) |
| | | | (QMCfor MBS) or | may indicate the service type |
| | | | ENUMERATED | of QoE measurements. |
| | | | (QMC for broadcast, | |
| | | | QMC for multicast) | |
| Non- | O | | ENUMERATED | With this indicator, the |
| CONNECTED | | | (No-CONNECTED, | logged QoE can be |
| Indicator | | | CONNECTED . . . ) or | performed/activated when the |
| | | | ENUMERATED | UE is in the RRC_IDLE or |
| | | | (True, . . . ) or | the RRC_INACTIVE. |
| | | | ENUMERATED | |
| | | | (RRC_CONNECTED, | |
| | | | RRC_INACTIVE, | |
| | | | RRC_IDLE . . . ), or | |
| | | | ENUMERATED | |
| | | | (Non- | |
| | | | CONNECTED, . . . ), | |
| | | | or ENUMERATED | |
| | | | (RRC_INACTIVE | |
| | | | and RRC_IDLE, . . . ), | |
| | | | or others | |
| Measurement | M | | Transport Layer | The IP address of the entity |
| Collection Entity | | | Address | receiving the QoE |
| IP Address | | | | measurement report. |
| Container for | O | | OCTET STRING | Application layer |
| Application Layer | | | | measurement configuration. |
| Measurement | | | | |
| Configuration | | | | |
| Other QoE config | . . . | . . . | . . . | . . . |

### Implementation Example 2-Logged QoE Configured without Non-CONNECTED Indicator (CONNECTED Logged QoE)

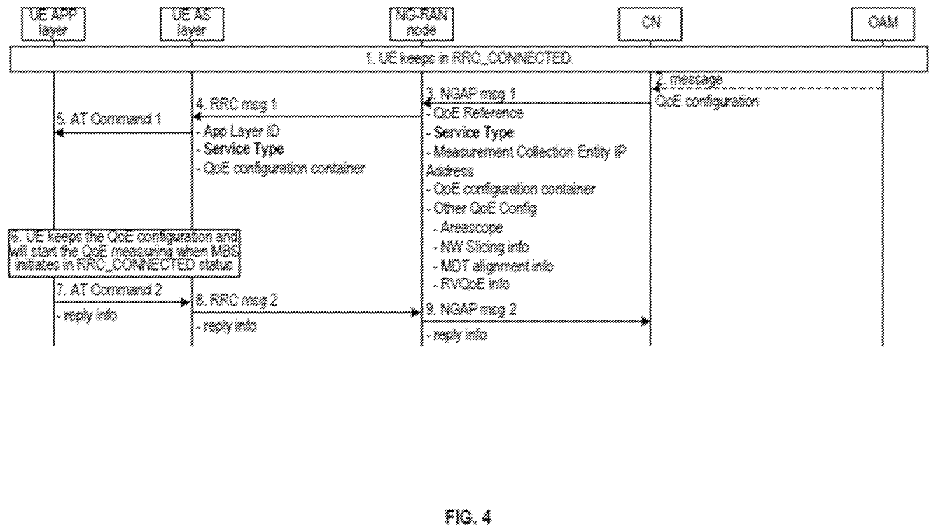

FIG. 4 is a sequence diagram illustrating a procedure for a logged QoE, in accordance with some embodiments. The procedure may be perform by a UE application (APP) layer, a UE access stratum (AS) layer, a next generation radio access network (NG-RAN) node, a core network (CN), and an operations and maintenance (OAM). It is noted that the procedure is merely an example, and is not intended to limit the present disclosure. Accordingly, it is understood that additional operations (e.g., blocks) may be provided before, during, and after the procedure of FIG. 4, certain operations may be omitted, certain operations may be performed concurrently with other operations, and that some other operations may be briefly described herein. Without a non-CONNECTED indicator, a logged QoE can be only performed when a UE is in RRC_CONNECTED state.

In step 1, a UE can be in an RRC_CONNECTED state before a logged QoE configuration. The logged QoE configuration may trigger a QoE reporting behavior in any RRC status/state. The UE can transmit QoE reports to the network when the UE enters RRC_CONNECTED state.

In step 2, an OAM may send the logged QoE configuration to a CN by a no standardization message.

In step 3, the CN may send a NG application protocol (AP) message 1 to a NG-RAN node within the logged QoE configuration message. The NGAP message 1 may include at least one of the following information: a QoE reference; a service type; a Measurement Collector Entity (MCE) IP address; or a QoE configuration container. The QoE reference ID can be configured by the OAM. The QoE reference ID may be used/utilized/applied to mark the logged QoE in some steps. The service type can be MBS, broadcast, or multicast. In this implementation example, the service type can be MBS. The service type can also be broadcast or multicast in some alternative examples. In some embodiments, when the logged QoE generates QoE measurement data, the data may be forwarded to the MCE IP address. The QoE configuration container may contain/include a full logged QoE configuration. The other QoE configuration parameters contained/included in step 3 of the procedure/call flow may be discussed in other implementation examples. In certain embodiments, the QoE configuration in step 3 may include at least one of the following information: a QoE reference; a sub-service type (e.g., broadcast or multicast); a Measurement Collector Entity (MCE) IP address; or a QoE configuration container. In some embodiments, when a state indicator is absent in the configuration, the UE can only trigger/perform a measurement of the QoE in a RRC_CONNECTED state.

In step 4, after the NG-RAN node receives the logged QoE configuration from the CN, the NG-RAN may send a RRC message 1 to a UE. The RRC message 1 may include at least one of the following information: an application (APP) layer identifier (ID); a service type; or a QoE configuration container. A RRC level ID may be used/utilized/applied to mark the logged QoE. In this implementation example, the service type can be MBS. The service type can also be broadcast or multicast in some alternative examples. The QoE configuration container may contain/include a full logged QoE configuration. In certain embodiments, the QoE configuration in step 4 may include at least one of the following information: an application (APP) layer identifier (ID); a sub-service type (e.g., multicast); or a QoE configuration container. In some embodiments, if a Short IP information is used as an indicator, the QoE configuration in step 4 may contain/include at least one of the following information: an application (APP) layer identifier (ID); a service type; or a QoE configuration container. If there is no short IP information in a QoE configuration message, the logged QoE can be only performed in RCC CONNECTED state.

In step 5, the UE may receive the QoE configuration. The UE AS layer may send the received QoE configuration to the UE APP layer via an ATtention (AT) command. The AT command can be used for controlling mobile termination (MT) functions and global system for mobiles (GSM)/universal mobile telecommunication system (UMTS) network services from a terminal equipment (TE) through terminal adaptor (TA).

In step 6, the UE may keep the QoE configuration and may start the logged QoE measuring when multicast and broadcast service (MBS) initiates in RCC_CONNECTED state.

In step 7, the UE APP layer may reply messages (e.g., AT command 2) for the AT command. In step 8, the UE AS layer may reply messages (e.g., RRC message 2) for the RRC message. In step 9, the NG-RAN node may reply messages (e.g., NGAP message 2) for the NGAP message. In some embodiments, acknowledge (ACK) information can be used to indicate that the previous message is received successfully. The ACK information may be contained in the messages. The ACK information may be null (e.g., no related information) or an indicator (e.g., indicating everything works normally).

Table 4 shows key points for step 3 with the service type and non-CONNECTED indicator.

TABLE 4

| IE/Group Name | Presence | Range | IE type and reference | Semantics description |
|---|---|---|---|---|
| QoE Reference | M | | OCTET STRING | QoE Reference may comprise |
| | | | (SIZE(6)) | mobile country code (MCC), |
| | | | | mobile network code (MNC), |
| | | | | and QoE measurement |
| | | | | collection (QMC) ID. The MCC |
| | | | | and MNC can be with trace |
| | | | | activation request from a |
| | | | | management system to identify |
| | | | | one public land mobile network |
| | | | | (PLMN) containing the |
| | | | | management system. The QMC |
| | | | | ID can be a 3-bytes Octet String. |
| Service Type | M | | ENUMERATED(QMCfor | This information element (IE) |
| | | | MBS) or | may indicate the service type of |
| | | | ENUMERATED(QMC | QoE measurements. |
| | | | for broadcast, QMC | |
| | | | for multicast) | |
| Measurement | M | | Transport Layer Address | The IP address of the entity |
| Collection Entity | | | | receiving the QoE measurement |
| IP Address | | | | report. |
| Container for | O | | OCTET STRING | Application layer measurement |
| Application Layer | | | | configuration. |
| Measurement | | | | |
| Configuration | | | | |
| Other QoE config | . . . | . . . | . . . | . . . |

Besides the above two implementation examples, there may be another way to define an indicator. The indicator can be used to indicate/specify whether the logged QoE can be performed in the following two cases: (i) a logged QoE can be performed in RRC_CONNECTED, RRC_INACTIVE, or RRC_IDLE; (ii) a logged QoE can be performed in RRC_CONNECTED. With the indicator, the logged QoE can be performed in any RRC state (e.g., RRC_CONNECTED, RRC_INACTIVE, or RRC_IDLE). Without the indicator, the logged QoE can be only performed in RRC_CONNECTED. In certain embodiments, with the indicator, the logged QoE can be performed in RRC_CONNECTED. Without the indicator, the logged QoE can be performed in any RRC state. “Performed in any RRC state” may indicate/mean that the logged QoE can be activated and can keep measuring logged QoE data in any RRC state. In addition to the indicator, the sub-service type (e.g., broadcast or multicast) can be used here. For a “Broadcast” logged QoE, it can be performed in any RRC state. For a “Multicast” logged QoE, it can be only performed in CONNECTED state. In some embodiments, the short IP information can be also used as a kind of all RRC state indicator in some messages.

### Implementation Example 3-Logged QoE Configured with any State Indicator (any RRC State Logged QoE)

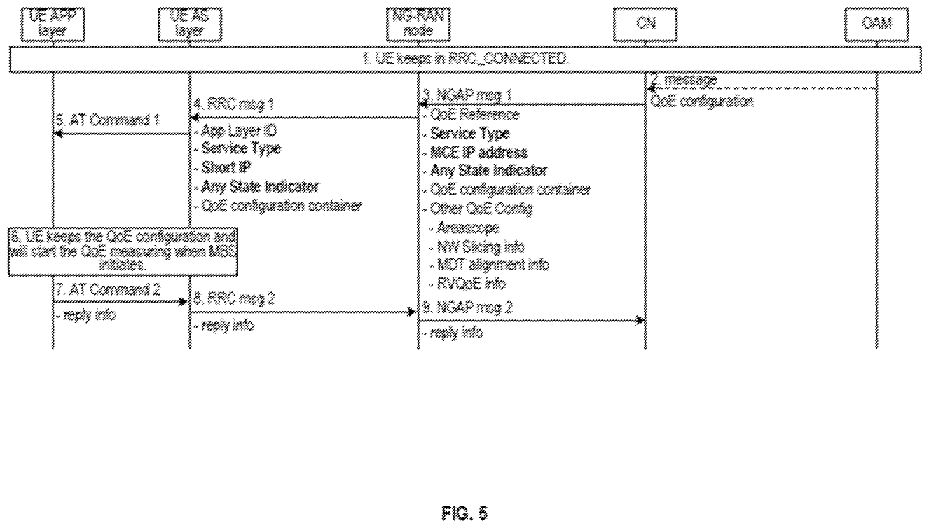

FIG. 5 is a sequence diagram illustrating a procedure for a logged QoE, in accordance with some embodiments. The procedure may be perform by a UE application (APP) layer, a UE access stratum (AS) layer, a next generation radio access network (NG-RAN) node, a core network (CN), and an operations and maintenance (OAM). It is noted that the procedure is merely an example, and is not intended to limit the present disclosure. Accordingly, it is understood that additional operations (e.g., blocks) may be provided before, during, and after the procedure of FIG. 5, certain operations may be omitted, certain operations may be performed concurrently with other operations, and that some other operations may be briefly described herein.

In step 1, a UE can be in an RRC_CONNECTED state before a logged QoE configuration. The logged QoE configuration may trigger a QoE reporting behavior in any RRC status/state. The UE can transmit QoE reports to the network when the UE enters RRC_CONNECTED state.

In step 2, an OAM may send the logged QoE configuration to a CN by a no standardization message.

In step 3, the CN may send a NG application protocol (AP) message 1 to a NG-RAN node within the logged QoE configuration message. The NGAP message 1 may include at least one of the following information: a QoE reference; a service type; a state indicator (any state indicator); a Measurement Collector Entity (MCE) IP address; or a QoE configuration container. The QoE reference ID can be configured by the OAM. The QoE reference ID may be used/utilized/applied to mark the logged QoE in some steps. The service type can be MBS, broadcast, or multicast. In this implementation example, the service type can be MBS. The service type can also be broadcast or multicast in some alternative examples. The state indicator can be any state indicator. The any state indicator may indicate that the logged QoE measurement can be performed/triggered in any RRC state (e.g., RRC_CONNECTED state, the RRC_INACTIVE state, or the RRC_IDLE state). In some embodiments, when the logged QoE generates QoE measurement data, the data may be forwarded to the MCE IP address. The QoE configuration container may contain/include a full logged QoE configuration. The other QoE configuration parameters contained/included in step 3 of the procedure/call flow may be discussed in other implementation examples. In certain embodiments, the QoE configuration in step 3 may include at least one of the following information: a QoE reference; a sub-service type (e.g., broadcast); a Measurement Collector Entity (MCE) IP address; or a QoE configuration container.

In step 4, after the NG-RAN node receives the logged QoE configuration from the CN, the NG-RAN may send a RRC message 1 to a UE. The RRC message 1 may include at least one of the following information: an application (APP) layer identifier (ID); a service type; a state indicator (any state indicator); Short IP information; or a QoE configuration container. A RRC level ID may be used/utilized/applied to mark the logged QoE. In this implementation example, the service type can be MBS. The service type can also be broadcast or multicast in some alternative examples. The state indicator can be any state indicator. The any state indicator may indicate that the logged QoE can be performed when the UE is in both RRC_IDLE and RRC_INACTIVE state. The Short IP information may be used/utilized/applied by the NG-RAN to retrieve the real IP address of the MCE. The QoE configuration container may contain/include a full logged QoE configuration. In certain embodiments, the QoE configuration in step 4 may include at least one of the following information: an application (APP) layer identifier (ID); a sub-service type (e.g., broadcast); Short IP information; or a QoE configuration container. In some embodiments, if a Short IP information is used as an indicator, the QoE configuration in step 4 may contain/include at least one of the following information: an application (APP) layer identifier (ID); a service type; Short IP information; or a QoE configuration container.

In step 5, the UE may receive the QoE configuration. The UE AS layer may send the received QoE configuration to the UE APP layer via an ATtention (AT) command. The AT command can be used for controlling mobile termination (MT) functions and global system for mobiles (GSM)/universal mobile telecommunication system (UMTS) network services from a terminal equipment (TE) through terminal adaptor (TA).

In step 6, the UE may keep the QoE configuration and may start the logged QoE measuring when multicast and broadcast service (MBS) starts an indicated state.

In step 7, the UE APP layer may reply messages (e.g., AT command 2) for the AT command. In step 8, the UE AS layer may reply messages (e.g., RRC message 2) for the RRC message. In step 9, the NG-RAN node may reply messages (e.g., NGAP message 2) for the NGAP message. In some embodiments, acknowledge (ACK) information can be used to indicate that the previous message is received successfully. The ACK information may be contained in the messages. The ACK information may be null (e.g., no related information) or an indicator (e.g., indicating everything works normally).

Table 5 shows key points for step 3 with the service type and any state indicator.

TABLE 5

| IE/Group Name | Presence | Range | IE type and reference | Semantics description |
|---|---|---|---|---|
| QoE Reference | M | | OCTET STRING | QoE Reference may comprise |
| | | | (SIZE(6)) | mobile country code (MCC), |
| | | | | mobile network code (MNC), |
| | | | | and QoE measurement |
| | | | | collection (QMC) ID. The MCC |
| | | | | and MNC can be with trace |
| | | | | activation request from a |
| | | | | management system to identify |
| | | | | one public land mobile network |
| | | | | (PLMN) containing the |
| | | | | management system. The QMC |
| | | | | ID can be a 3-bytes Octet String. |
| Service Type | M | | ENUMERATED(QMCfor | This information element (IE) |
| | | | MBS) or | may indicate the service type of |
| | | | ENUMERATED(QMCfor | QoE measurements. |
| | | | broadcast, QMC | |
| | | | for multicast) | |
| Any State | O | | ENUMERATED (Any | With this indicator, the logged |
| Indicator | | | State, only | QoE can be performed/activated |
| | | | CONNECTED . . . ) | when the UE is in the |
| | | | or ENUMERATED | RRC_CONNECTED, |
| | | | (True, . . . ), or | RRC_INACTIVE, or |
| | | | ENUMERATED (Any | RRC_IDLE. |
| | | | state, . . . ), or | |
| | | | ENUMERATED | |
| | | | (RRC_CONNECTED | |
| | | | &RRC_INACTIVE& | |
| | | | RRC_IDLE, . . . ) | |
| Measurement | M | | Transport Layer Address | The IP address of the entity |
| Collection Entity | | | | receiving the QoE measurement |
| IP Address | | | | report. |
| Container for | O | | OCTET STRING | Application layer measurement |
| Application Layer | | | | configuration. |
| Measurement | | | | |
| Configuration | | | | |
| Other QoE config | . . . | . . . | . . . | . . . |

Table 6 shows key points for step 3 with the service type and CONNECTED indicator. With the indicator, the logged QoE can only perform in RRC_CONNECTED. In this case, the QoE configuration may not contain the indicator.

TABLE 6

| IE/Group Name | Presence | Range | IE type and reference | Semantics description |
|---|---|---|---|---|
| QoE Reference | M | | OCTET STRING | QoE Reference may comprise |
| | | | (SIZE(6)) | mobile country code (MCC), |
| | | | | mobile network code (MNC), |
| | | | | and QoE measurement |
| | | | | collection (QMC) ID. The |
| | | | | MCC and MNC can be with |
| | | | | trace activation request from |
| | | | | a management system to |
| | | | | identify one public land |
| | | | | mobile network (PLMN) |
| | | | | containing the management |
| | | | | system. The QMC ID can be |
| | | | | a 3-bytes Octet String. |
| Service Type | M | | ENUMERATED(QMCfor | This information element (IE) |
| | | | MBS) or | may indicate the service type |
| | | | ENUMERATED(QMCfor | of QoE measurements. |
| | | | broadcast, QMC | |
| | | | for multicast) | |
| CONNECTED | O | | ENUMERATED | With this indicator, the |
| Indicator | | | (Any state, Only | logged QoE can be |
| | | | CONNECTED . . . ) | performed/activated when the |
| | | | or ENUMERATED | UE is in the |
| | | | (True, . . . ) or | RRC_CONNECTED. |
| | | | ENUMERATED | |
| | | | (RRC_CONNECTED, | |
| | | | . . . ), or others | |
| Measurement | M | | Transport Layer Address | The IP address of the entity |
| Collection Entity | | | | receiving the QoE |
| IP Address | | | | measurement report. |
| Container for | O | | OCTET STRING | Application layer |
| Application Layer | | | | measurement configuration. |
| Measurement | | | | |
| Configuration | | | | |
| Other QoE config | . . . | . . . | . . . | . . . |

### Implementation Example 4-Logged QoE Configured with New Radio (NR) QoE Procedure

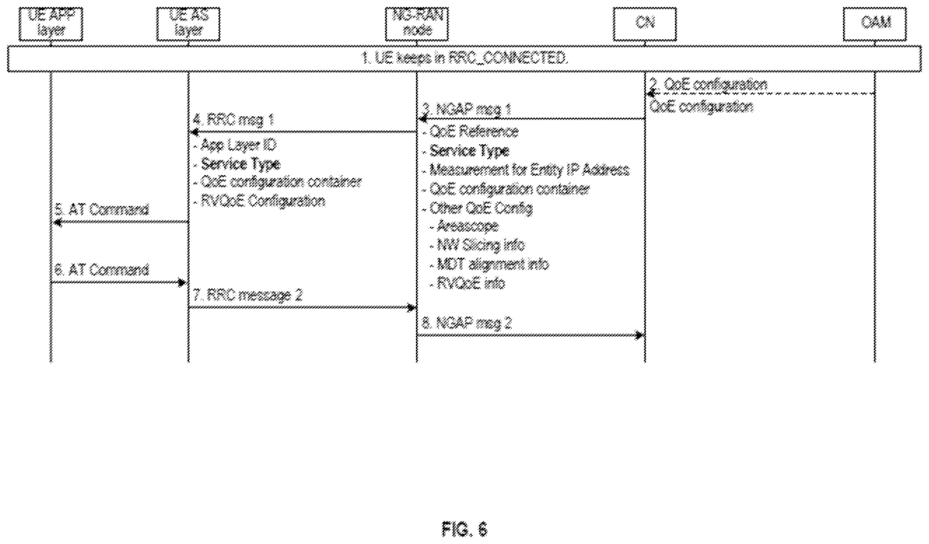

FIG. 6 is a sequence diagram illustrating a procedure for a logged QoE, in accordance with some embodiments. The procedure may be perform by a UE application (APP) layer, a UE access stratum (AS) layer, a next generation radio access network (NG-RAN) node, a core network (CN), and an operations and maintenance (OAM). It is noted that the procedure is merely an example, and is not intended to limit the present disclosure. Accordingly, it is understood that additional operations (e.g., blocks) may be provided before, during, and after the procedure of FIG. 6, certain operations may be omitted, certain operations may be performed concurrently with other operations, and that some other operations may be briefly described herein. The logged QoE can be only performed in RRC_CONNECTED state.

In step 1, a UE can be in an RRC_CONNECTED state.

In step 2, an OAM may send a logged QoE configuration to a CN. The logged QoE configuration may trigger a QoE reporting behavior in any RRC status/state. The UE can transmit QoE reports to the network when the UE enters RRC_CONNECTED state.

In step 3, the CN may send a NG application protocol (AP) message 1 to a NG-RAN node. The new radio (NR) QoE configuration information elements (IEs) can be reused to the logged QoE configuration except a service type can be MBS, multicast, or broadcast.

In step 4, the NG-RAN may send a RRC message 1 to a UE. The new radio (NR) QoE configuration information elements (IEs) can be reused to the logged QoE configuration except a service type can be MBS, multicast, or broadcast.

In step 5 and step 6, a UE AS layer and a UE APP layer may exchange information about the logged QoE via ATtention (AT) commands.

In step 7, the UE AS layer may reply messages (e.g., RRC message 2) for the RRC message 1. In step 8, the NG-RAN node may reply messages (e.g., NGAP message 2) for the NGAP message 1. In some embodiments, acknowledge (ACK) information can be used to indicate that the previous message is received successfully. The ACK information may be contained in the messages. The ACK information may be null (e.g., no related information) or an indicator (e.g., indicating everything works normally).

Table 7 shows key points for step 3 with a sub-service type (e.g., broadcast).

TABLE 7

| IE/Group Name | Presence | Range | IE type and reference | Semantics description |
|---|---|---|---|---|
| QoE Reference | M | | OCTET STRING | QoE Reference may comprise |
| | | | (SIZE(6)) | mobile country code (MCC), |
| | | | | mobile network code (MNC), and |
| | | | | QoE measurement collection |
| | | | | (QMC) ID. The MCC and MNC |
| | | | | can be with trace activation request |
| | | | | from a management system to |
| | | | | identify one public land mobile |
| | | | | network (PLMN) containing the |
| | | | | management system. The QMC |
| | | | | ID can be a 3-bytes Octet String. |
| Service Type | M | | ENUMERATED(QMCfor | This information element (IE) may |
| | | | Broadcast, QMC | indicate the service type of QoE |
| | | | for Multicast) | measurements. |
| Measurement | M | | Transport Layer Address | The IP address of the entity |
| Collection Entity | | | | receiving the QoE measurement |
| IP Address | | | | report. |
| Container for | O | | OCTET STRING | Application layer measurement |
| Application Layer | | | | configuration. |
| Measurement | | | | |
| Configuration | | | | |
| Other QoE config | . . . | . . . | . . . | . . . |

Table 8 shows key points for step 3 with a sub-service type (e.g., multicast).

TABLE 8

| IE/Group Name | Presence | Range | IE type and reference | Semantics description |
|---|---|---|---|---|
| QoE Reference | M | | OCTET STRING | QoE Reference may comprise |
| | | | (SIZE(6)) | mobile country code (MCC), |
| | | | | mobile network code (MNC), |
| | | | | and QoE measurement |
| | | | | collection (QMC) ID. The |
| | | | | MCC and MNC can be with |
| | | | | trace activation request from |
| | | | | a management system to |
| | | | | identify one public land |
| | | | | mobile network (PLMN) |
| | | | | containing the management |
| | | | | system. The QMC ID can be |
| | | | | a 3-bytes Octet String. |
| Service Type | M | | ENUMERATED(QMCfor | This information element (IE) |
| | | | Broadcast, QMC | may indicate the service type |
| | | | for Multicast) | of QoE measurements. |
| Measurement | M | | Transport Layer Address | The IP address of the entity |
| Collection Entity | | | | receiving the QoE |
| IP Address | | | | measurement report. |
| Container for | O | | OCTET STRING | Application layer |
| Application Layer | | | | measurement configuration. |
| Measurement | | | | |
| Configuration | | | | |
| Other QoE config | . . . | . . . | . . . | . . . |

Table 9 shows key points for step 3 with a sub-service type (e.g., MBS).

TABLE 9

| IE/Group Name | Presence | Range | IE type and reference | Semantics description |
|---|---|---|---|---|
| QoE Reference | M | | OCTET STRING | QoE Reference may comprise |
| | | | (SIZE(6)) | mobile country code (MCC), |
| | | | | mobile network code (MNC), |
| | | | | and QoE measurement |
| | | | | collection (QMC) ID. The |
| | | | | MCC and MNC can be with |
| | | | | trace activation request from |
| | | | | a management system to |
| | | | | identify one public land |
| | | | | mobile network (PLMN) |
| | | | | containing the management |
| | | | | system. The QMC ID can be |
| | | | | a 3-bytes Octet String. |
| Service Type | M | | ENUMERATED(QMCfor | This information element (IE) |
| | | | MBS) | may indicate the service type |
| | | | | of QoE measurements. |
| Measurement | M | | Transport Layer Address | The IP address of the entity |
| Collection Entity | | | | receiving the QoE |
| IP Address | | | | measurement report. |
| Container for | O | | OCTET STRING | Application layer |
| Application Layer | | | | measurement configuration. |
| Measurement | | | | |
| Configuration | | | | |
| Other QoE config | . . . | . . . | . . . | . . . |

### Implementation Example 5-Logged QoE Configured with CONNECTED Indicator (CONNECTED Logged QoE)

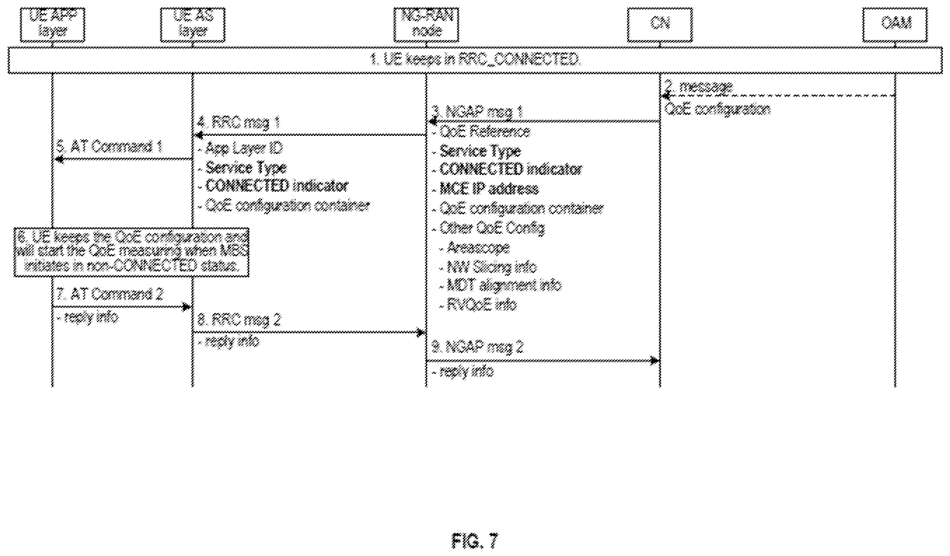

FIG. 7 is a sequence diagram illustrating a procedure for a logged QoE, in accordance with some embodiments. The procedure may be perform by a UE application (APP) layer, a UE access stratum (AS) layer, a next generation radio access network (NG-RAN) node, a core network (CN), and an operations and maintenance (OAM). It is noted that the procedure is merely an example, and is not intended to limit the present disclosure. Accordingly, it is understood that additional operations (e.g., blocks) may be provided before, during, and after the procedure of FIG. 7, certain operations may be omitted, certain operations may be performed concurrently with other operations, and that some other operations may be briefly described herein. This implementation example shares the similar procedure as described in implementation example 1 (e.g., a service type with an indicator).

In step 1, a UE may be in an RRC_CONNECTED state before a logged QoE configuration.

In step 2, an OAM may send a logged QoE configuration to a CN by a no standardization message. The logged QoE configuration may trigger a QoE reporting behavior in any RRC status/state. The UE can transmit QoE reports to the network when the UE enters RRC_CONNECTED state.

In step 3, the CN may send a NG application protocol (AP) message 1 to a NG-RAN node within the logged QoE configuration message. The NGAP message 1 may include at least one of the following information: a QoE reference; a service type; a state indicator (CONNECTED indicator); a Measurement Collector Entity (MCE) IP address; or a QoE configuration container. The QoE reference ID can be configured by the OAM. The QoE reference ID may be used/utilized/applied to mark the logged QoE in some steps. The service type can be MBS, broadcast, or multicast. In this implementation example, the service type can be MBS. The service type can also be broadcast or multicast in some alternative examples. The state indicator can be CONNECTED indicator. The CONNECTED indicator may indicate that the logged QoE can be performed/triggered when the UE is in an RRC_CONNECTED state. In certain embodiments, if the CONNECTED indicator is used without a state indicator, the logged QoE may be performed/triggered when the UE is in a non-CONNECTED state (e.g., RRC_IDLE or RRC_INACTIVE). In some embodiments, when the logged QoE generates QoE measurement data, the data may be forwarded to the MCE IP address. The QoE configuration container may contain/include a full logged QoE configuration. The other QoE configuration parameters contained/included in step 3 of the procedure/call flow may be discussed in other implementation examples.

In step 4, after the NG-RAN node receives the logged QoE configuration from the CN, the NG-RAN may send a RRC message 1 to a UE. The RRC message 1 may include at least one of the following information: an application (APP) layer identifier (ID); a service type; a state indicator (CONNECTED indicator); Short IP information; or a QoE configuration container. A RRC level ID may be used/utilized/applied to mark the logged QoE. In this implementation example, the service type can be MBS. The service type can also be broadcast or multicast in some alternative examples. The state indicator can be CONNECTED indicator. The CONNECTED indicator may indicate that the logged QoE can be performed when the UE is in an RRC_CONNECTED state. In certain embodiments, if the CONNECTED indicator is used without a state indicator, the logged QoE may be performed/triggered when the UE is in a non-CONNECTED state (e.g., RRC_IDLE or RRC_INACTIVE). The Short IP information may be used/utilized/applied by the NG-RAN to retrieve the real IP address of the MCE. In some embodiments, the Short IP information may also be used as a state indicator (CONNECTED indicator). When the UE receives the service type and the short IP information, the UE may know/notice/be aware the logged QoE can be only performed in CONENCTED state. In such case, the state indicator (CONNECTED indicator) may be omitted in the RRC configuration message. The QoE configuration container may contain/include a full logged QoE configuration. For the short IP information used as a state indicator, the QoE configuration in step 4 may contain/include at least one of the following information: a QoE reference, a service type, a short IP information, or a QoE configuration container. In some embodiments, if the short IP information is used as a state indicator, the short IP information may not be forwarded to the UE.

In step 5, the UE may receive the QoE configuration. The UE AS layer may send the received QoE configuration to the UE APP layer via an ATtention (AT) command. The AT command can be used for controlling mobile termination (MT) functions and global system for mobiles (GSM)/universal mobile telecommunication system (UMTS) network services from a terminal equipment (TE) through terminal adaptor (TA).

In step 6, the UE may keep the QoE configuration and may start the logged QoE measuring when multicast and broadcast service (MBS) initiates in either RRC_IDLE or RRC_INACTIVE state.

In step 7, the UE APP layer may reply messages (e.g., AT command 2) for the AT command. In step 8, the UE AS layer may reply messages (e.g., RRC message 2) for the RRC message. In step 9, the NG-RAN node may reply messages (e.g., NGAP message 2) for the NGAP message. In some embodiments, acknowledge (ACK) information can be used to indicate that the previous message is received successfully. The ACK information may be contained in the messages. The ACK information may be null (e.g., no related information) or an indicator (e.g., indicating everything works normally).

Table 10 shows key points for step 3.

TABLE 10

| IE/Group Name | Presence | Range | IE type and reference | Semantics description |
|---|---|---|---|---|
| QoE Reference | M | | OCTET STRING | QoE Reference may comprise |
| | | | (SIZE(6)) | mobile country code (MCC), |
| | | | | mobile network code (MNC), |
| | | | | and QoE measurement |
| | | | | collection (QMC) ID. The |
| | | | | MCC and MNC can be with |
| | | | | trace activation request from a |
| | | | | management system to identify |
| | | | | one public land mobile network |
| | | | | (PLMN) containing the |
| | | | | management system. The |
| | | | | QMC ID can be a 3-bytes Octet |
| | | | | String. |
| Service Type | M | | ENUMERATED(QMCfor | This information element (IE) |
| | | | MBS) or | may indicate the service type of |
| | | | ENUMERATED(QMCfor | QoE measurements. |
| | | | broadcast, QMC | |
| | | | for multicast) | |
| CONNECTED | O | | ENUMERATED | With this indicator, the logged |
| Indicator | | | (No-CONNECTED, | QoE can be performed/activated |
| | | | CONNECTED . . . ) | when the UE is in the |
| | | | or ENUMERATED | RRC_CONNECTED. |
| | | | (True, . . . ) or | |
| | | | ENUMERATED | |
| | | | (RRC_CONNECTED, | |
| | | | RRC_INACTIVE, | |
| | | | RRC_IDLE . . . ), | |
| | | | or ENUMERATED | |
| | | | (RRC_CONNECTED, | |
| | | | . . . ), or others | |
| Measurement | M | | Transport Layer Address | The IP address of the entity |
| Collection Entity | | | | receiving the QoE |
| IP Address | | | | measurement report. |
| Container for | O | | OCTET STRING | Application layer measurement |
| Application Layer | | | | configuration. |
| Measurement | | | | |
| Configuration | | | | |
| Other QoE config | . . . | . . . | . . . | . . . |

### Implementation Example 6-Logged QoE Configured without CONNECTED Indicator (Non-CONNECTED Logged QoE)

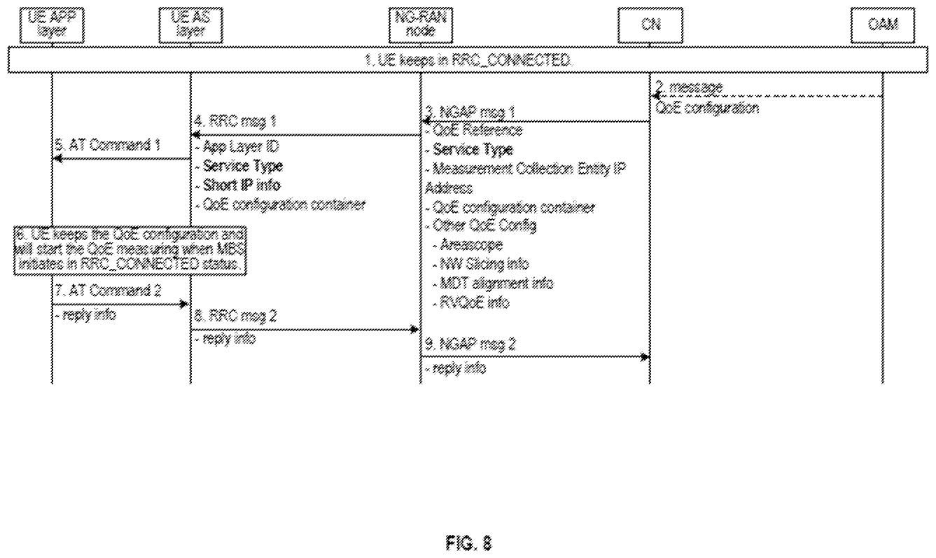

FIG. 8 is a sequence diagram illustrating a procedure for a logged QoE, in accordance with some embodiments. The procedure may be perform by a UE application (APP) layer, a UE access stratum (AS) layer, a next generation radio access network (NG-RAN) node, a core network (CN), and an operations and maintenance (OAM). It is noted that the procedure is merely an example, and is not intended to limit the present disclosure. Accordingly, it is understood that additional operations (e.g., blocks) may be provided before, during, and after the procedure of FIG. 8, certain operations may be omitted, certain operations may be performed concurrently with other operations, and that some other operations may be briefly described herein. Without a non-CONNECTED indicator, a logged QoE can be only performed when a UE is in RRC_CONNECTED state. This implementation example shares the similar procedure as described in implementation example 2 (e.g., a service type without an indicator).

In step 1, a UE can be in an RRC_CONNECTED state before a logged QoE configuration. The logged QoE configuration may trigger a QoE reporting behavior in any RRC status/state. The UE can transmit QoE reports to the network when the UE enters RRC_CONNECTED state.

In step 2, an OAM may send the logged QoE configuration to a CN by a no standardization message.

In step 3, the CN may send a NG application protocol (AP) message 1 to a NG-RAN node within the logged QoE configuration message. The NGAP message 1 may include at least one of the following information: a QoE reference; a service type; a Measurement Collector Entity (MCE) IP address; or a QoE configuration container. The QoE reference ID can be configured by the OAM. The QoE reference ID may be used/utilized/applied to mark the logged QoE in some steps. The service type can be MBS, broadcast, or multicast. In this implementation example, the service type can be MBS. The service type can also be broadcast or multicast in some alternative examples. In some embodiments, when the logged QoE generates QoE measurement data, the data may be forwarded to the MCE IP address. The QoE configuration container may contain/include a full logged QoE configuration. The other QoE configuration parameters contained/included in step 3 of the procedure/call flow may be discussed in other implementation examples. In certain embodiments, the QoE configuration in step 3 may include at least one of the following information: a QoE reference; a sub-service type (e.g., broadcast); a Measurement Collector Entity (MCE) IP address; or a QoE configuration container.

In step 4, after the NG-RAN node receives the logged QoE configuration from the CN, the NG-RAN may send a RRC message 1 to a UE. The RRC message 1 may include at least one of the following information: an application (APP) layer identifier (ID); a service type; Short IP information; or a QoE configuration container. A RRC level ID may be used/utilized/applied to mark the logged QoE. In this implementation example, the service type can be MBS. The service type can also be broadcast or multicast in some alternative examples. The Short IP information may be used/utilized/applied by the NG-RAN to retrieve the real IP address of the MCE. In some embodiments, the Short IP information may also be used as a state indicator (non-CONNECTED indicator). When the UE receives the service type and the short IP information, the UE may know/notice/be aware the logged QoE can be only performed in non-CONENCTED state. In such case, the state indicator (non-CONNECTED indicator) may be omitted in the RRC configuration message. The QoE configuration container may contain/include a full logged QoE configuration. In certain embodiments, the QoE configuration in step 4 may include at least one of the following information: an application (APP) layer identifier (ID); a service type; Short IP information; or a QoE configuration container.

In step 5, the UE may receive the QoE configuration. The UE AS layer may send the received QoE configuration to the UE APP layer via an ATtention (AT) command. The AT command can be used for controlling mobile termination (MT) functions and global system for mobiles (GSM)/universal mobile telecommunication system (UMTS) network services from a terminal equipment (TE) through terminal adaptor (TA).

In step 6, the UE may keep the QoE configuration and may start the logged QoE measuring when multicast and broadcast service (MBS) initiates in RRC_CONNECTED state.

In step 7, the UE APP layer may reply messages (e.g., AT command 2) for the AT command. In step 8, the UE AS layer may reply messages (e.g., RRC message 2) for the RRC message. In step 9, the NG-RAN node may reply messages (e.g., NGAP message 2) for the NGAP message. In some embodiments, acknowledge (ACK) information can be used to indicate that the previous message is received successfully. The ACK information may be contained in the messages. The ACK information may be null (e.g., no related information) or an indicator (e.g., indicating everything works normally).

Table 11 shows key points for step 3.

TABLE 11

| IE/Group Name | Presence | Range | IE type and reference | Semantics description |
|---|---|---|---|---|
| QoE Reference | M | | OCTET STRING | QoE Reference may comprise |
| | | | (SIZE(6)) | mobile country code (MCC), |
| | | | | mobile network code (MNC), |
| | | | | and QoE measurement |
| | | | | collection (QMC) ID. The |
| | | | | MCC and MNC can be with |
| | | | | trace activation request from |
| | | | | a management system to |
| | | | | identify one public land |
| | | | | mobile network (PLMN) |
| | | | | containing the management |
| | | | | system. The QMC ID can be |
| | | | | a 3-bytes Octet String. |
| Service Type | M | | ENUMERATED(QMCfor | This information element (IE) |
| | | | MBS) or | may indicate the service type |
| | | | ENUMERATED(QMCfor | of QoE measurements. |
| | | | broadcast, | |
| | | | QMC for multicast) | |
| Measurement | M | | Transport Layer Address | The IP address of the entity |
| Collection Entity | | | | receiving the QoE |
| IP Address | | | | measurement report. |
| Container for | O | | OCTET STRING | Application layer |
| Application Layer | | | | measurement configuration. |
| Measurement | | | | |
| Configuration | | | | |
| Other QoE config | . . . | . . . | . . . | . . . |

### Implementation Example 7-Logged QoE Configured with Sub Service Type (“Multicast”) (CONNECTED Logged QoE)

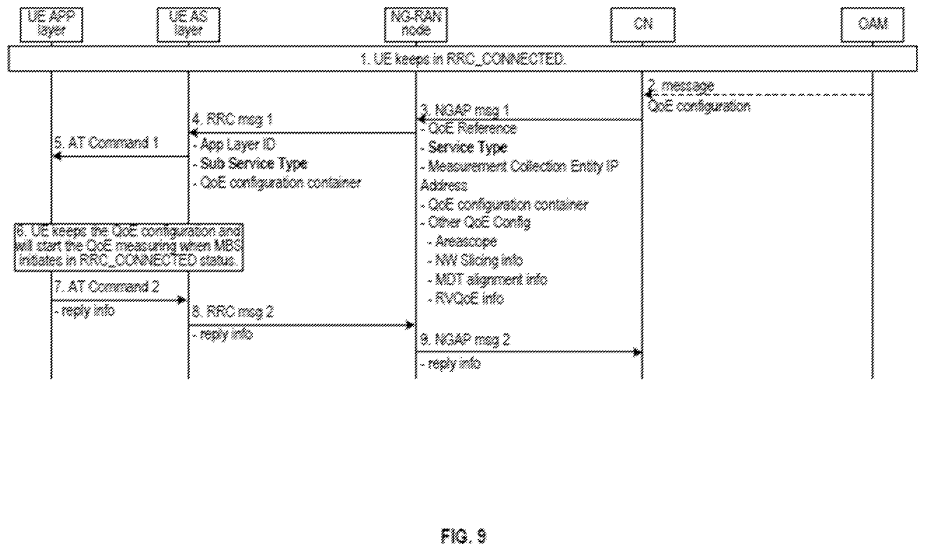

FIG. 9 is a sequence diagram illustrating a procedure for a logged QoE, in accordance with some embodiments. The procedure may be perform by a UE application (APP) layer, a UE access stratum (AS) layer, a next generation radio access network (NG-RAN) node, a core network (CN), and an operations and maintenance (OAM). It is noted that the procedure is merely an example, and is not intended to limit the present disclosure. Accordingly, it is understood that additional operations (e.g., blocks) may be provided before, during, and after the procedure of FIG. 9, certain operations may be omitted, certain operations may be performed concurrently with other operations, and that some other operations may be briefly described herein.

In step 1, a UE may be in an RRC_CONNECTED state before a logged QoE configuration. The logged QoE configuration may trigger a QoE reporting behavior in any RRC status/state. The UE can transmit QoE reports to the network when the UE enters RRC_CONNECTED state.

In step 2, an OAM may send the logged QoE configuration to a CN by a no standardization message.

In step 3, the CN may send a NG application protocol (AP) message 1 to a NG-RAN node within the logged QoE configuration message. The NGAP message 1 may include at least one of the following information: a QoE reference; a sub service type; a Measurement Collector Entity (MCE) IP address; or a QoE configuration container. The QoE reference ID can be configured by the OAM. The QoE reference ID may be used/utilized/applied to mark the logged QoE in some steps. The sub service type can be broadcast or multicast. In this implementation example, the sub service type can be multicast. In some embodiments, when the logged QoE generates QoE measurement data, the data may be forwarded to the MCE IP address. The QoE configuration container may contain/include a full logged QoE configuration. The other QoE configuration parameters contained/included in step 3 of the procedure/call flow may be discussed in other implementation examples.

In step 4, after the NG-RAN node receives the logged QoE configuration from the CN, the NG-RAN may send a RRC message 1 to a UE. The RRC message 1 may include at least one of the following information: an application (APP) layer identifier (ID); a sub service type; or a QoE configuration container. A RRC level ID may be used/utilized/applied to mark the logged QoE. In this implementation example, the sub service type can be multicast. The QoE configuration container may contain/include a full logged QoE configuration.

In step 5, the UE may receive the QoE configuration. The UE AS layer may send the received QoE configuration to the UE APP layer via an ATtention (AT) command. The AT command can be used for controlling mobile termination (MT) functions and global system for mobiles (GSM)/universal mobile telecommunication system (UMTS) network services from a terminal equipment (TE) through terminal adaptor (TA).

In step 6, the UE may keep the QoE configuration and may start the logged QoE measuring when multicast and broadcast service (MBS) initiates in RRC_CONNECTED state.

In step 7, the UE APP layer may reply messages (e.g., AT command 2) for the AT command. In step 8, the UE AS layer may reply messages (e.g., RRC message 2) for the RRC message. In step 9, the NG-RAN node may reply messages (e.g., NGAP message 2) for the NGAP message. In some embodiments, acknowledge (ACK) information can be used to indicate that the previous message is received successfully. The ACK information may be contained in the messages. The ACK information may be null (e.g., no related information) or an indicator (e.g., indicating everything works normally).

Table 12 shows key points for step 3.

TABLE 12

| IE/Group Name | Presence | Range | IE type and reference | Semantics description |
|---|---|---|---|---|
| QoE Reference | M | | OCTET STRING | QoE Reference may comprise |
| | | | (SIZE(6)) | mobile country code (MCC), |
| | | | | mobile network code (MNC), |
| | | | | and QoE measurement |
| | | | | collection (QMC) ID. The |
| | | | | MCC and MNC can be with |
| | | | | trace activation request from a |
| | | | | management system to |
| | | | | identify one public land |
| | | | | mobile network (PLMN) |
| | | | | containing the management |
| | | | | system. The QMC ID can be a |
| | | | | 3-bytes Octet String. |
| Service Type | M | | ENUMERATED(QMCfor | This information element (IE) |
| | | | Broadcast, | may indicate the service type |
| | | | QMC for Multicast) | of QoE measurements. |
| Measurement | M | | Transport Layer Address | The IP address of the entity |
| Collection Entity | | | | receiving the QoE |
| IP Address | | | | measurement report. |
| Container for | O | | OCTET STRING | Application layer |
| Application Layer | | | | measurement configuration. |
| Measurement | | | | |
| Configuration | | | | |
| Other QoE config | . . . | . . . | . . . | . . . |

### Implementation Example 8-Logged QoE Configured with Sub Service Type (“Broadcast”) (Any state Logged QoE)

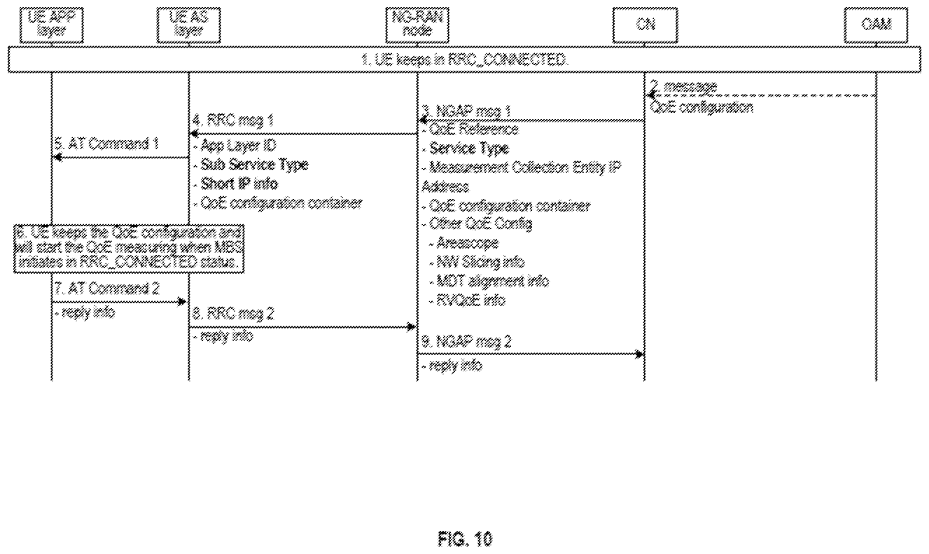

FIG. 10 is a sequence diagram illustrating a procedure for a logged QoE, in accordance with some embodiments. The procedure may be perform by a UE application (APP) layer, a UE access stratum (AS) layer, a next generation radio access network (NG-RAN) node, a core network (CN), and an operations and maintenance (OAM). It is noted that the procedure is merely an example, and is not intended to limit the present disclosure. Accordingly, it is understood that additional operations (e.g., blocks) may be provided before, during, and after the procedure of FIG. 10, certain operations may be omitted, certain operations may be performed concurrently with other operations, and that some other operations may be briefly described herein.

In step 1, a UE may be in an RRC_CONNECTED state before a logged QoE configuration. The logged QoE configuration may trigger a QoE reporting behavior in any RRC status/state. The UE can transmit QoE reports to the network when the UE enters RRC_CONNECTED state.

In step 2, an OAM may send the logged QoE configuration to a CN by a no standardization message.

In step 3, the CN may send a NG application protocol (AP) message 1 to a NG-RAN node within the logged QoE configuration message. The NGAP message 1 may include at least one of the following information: a QoE reference; a sub service type; a Measurement Collector Entity (MCE) IP address; or a QoE configuration container. The QoE reference ID can be configured by the OAM. The QoE reference ID may be used/utilized/applied to mark the logged QoE in some steps. The sub service type can be broadcast or multicast. In this implementation example, the sub service type can be broadcast. In some embodiments, when the logged QoE generates QoE measurement data, the data may be forwarded to the MCE IP address. The QoE configuration container may contain/include a full logged QoE configuration. The other QoE configuration parameters contained/included in step 3 of the procedure/call flow may be discussed in other implementation examples.

In step 4, after the NG-RAN node receives the logged QoE configuration from the CN, the NG-RAN may send a RRC message 1 to a UE. The RRC message 1 may include at least one of the following information: an application (APP) layer identifier (ID); a sub service type; Short IP information; or a QoE configuration container. A RRC level ID may be used/utilized/applied to mark the logged QoE. In this implementation example, the sub service type can be broadcast. The Short IP information may be used/utilized/applied by the NG-RAN to retrieve the real IP address of the MCE. The QoE configuration container may contain/include a full logged QoE configuration.

In step 5, the UE may receive the QoE configuration. The UE AS layer may send the received QoE configuration to the UE APP layer via an ATtention (AT) command. The AT command can be used for controlling mobile termination (MT) functions and global system for mobiles (GSM)/universal mobile telecommunication system (UMTS) network services from a terminal equipment (TE) through terminal adaptor (TA).

In step 6, the UE may keep the QoE configuration and may start the logged QoE measuring when multicast and broadcast service (MBS) initiates in an indicated state.

In step 7, the UE APP layer may reply messages (e.g., AT command 2) for the AT command. In step 8, the UE AS layer may reply messages (e.g., RRC message 2) for the RRC message. In step 9, the NG-RAN node may reply messages (e.g., NGAP message 2) for the NGAP message. In some embodiments, acknowledge (ACK) information can be used to indicate that the previous message is received successfully. The ACK information may be contained in the messages. The ACK information may be null (e.g., no related information) or an indicator (e.g., indicating everything works normally).

Table 13 shows key points for step 3.

TABLE 13

| IE/Group Name | Presence | Range | IE type and reference | Semantics description |
|---|---|---|---|---|
| QoE Reference | M | | OCTET STRING | QoE Reference may comprise |
| | | | (SIZE(6)) | mobile country code (MCC), |
| | | | | mobile network code (MNC), |
| | | | | and QoE measurement |
| | | | | collection (QMC) ID. The |
| | | | | MCC and MNC can be with |
| | | | | trace activation request from a |
| | | | | management system to |
| | | | | identify one public land |
| | | | | mobile network (PLMN) |
| | | | | containing the management |
| | | | | system. The QMC ID can be a |
| | | | | 3-bytes Octet String. |
| Service Type | M | | ENUMERATED(QMCfor | This information element (IE) |
| | | | Broadcast, | may indicate the service type |
| | | | QMC for Multicast) | of QoE measurements. |
| Measurement | M | | Transport Layer Address | The IP address of the entity |
| Collection Entity | | | | receiving the QoE |
| IP Address | | | | measurement report. |
| Container for | O | | OCTET STRING | Application layer |
| Application Layer | | | | measurement configuration. |
| Measurement | | | | |
| Configuration | | | | |
| Other QoE config | . . . | . . . | . . . | . . . |

Based on the above implementation examples, a logged QoE can perform in three scenarios: CONNECTED state (e.g., only RRC_CONNECTED), non-CONNECTED state (e.g., either RRC_INACTIVE or RRC_IDLE), and/or any RRC state (e.g., RRC_CONNECTED, RRC_IDLE, and/or RRC_INACTIVE). This part is only to discuss the other QoE parameters in the QoE configuration message. The combination of the service type and the state indicator (or the service type and the sub service type) can be excluded.

### Implementation Example 9-Connected Only Logged QoE Other QoE Config Configuration

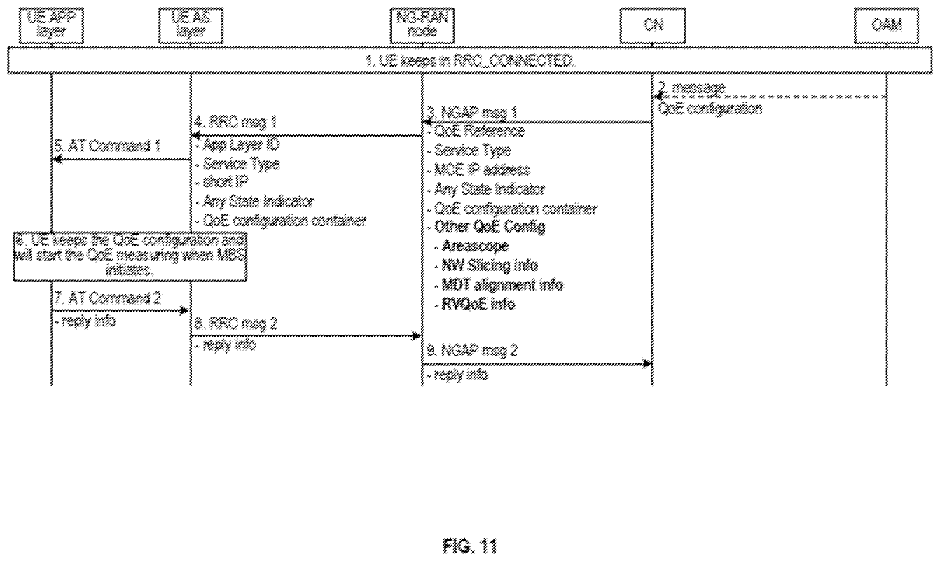

FIG. 11 is a sequence diagram illustrating a procedure for a logged QoE, in accordance with some embodiments. The procedure may be perform by a UE application (APP) layer, a UE access stratum (AS) layer, a next generation radio access network (NG-RAN) node, a core network (CN), and an operations and maintenance (OAM). It is noted that the procedure is merely an example, and is not intended to limit the present disclosure. Accordingly, it is understood that additional operations (e.g., blocks) may be provided before, during, and after the procedure of FIG. 11, certain operations may be omitted, certain operations may be performed concurrently with other operations, and that some other operations may be briefly described herein. This implementation example includes the same procedure/steps as described in implementation example 2.

In step 3, a CN may send a NG application protocol (AP) message 1 to a NG-RAN node within a logged QoE configuration message. The NGAP message 1 may include at least one of the following information: a QoE reference; a service type; a state indicator (any state indicator); a Measurement Collector Entity (MCE) IP address; or a QoE configuration container. In certain embodiments, the NGAP message 1 may further include at least one of the following information: an area scope associated with the QoE; network (NW) slicing information associated with the QoE; Minimization of Driving Test (MDT) alignment information associated with the QoE; or Radio Access Network Visible (RV) QoE. The area scope may be an optional parameter. If the area scope is configured, the value may be “void” (e.g., indicating a parameter is configured without value or null value), or a subset of the MBS service area (e.g., the area scope of the logged QoE may not be larger than the MBS service area). The NW slicing information may be an optional parameter. A value of the NW slicing information can be void (e.g., indicating a parameter is configured without value or null value), as same as a MBS NW slicing information or NW slicing information other than MBS's. The MDT alignment information may be optional. The NW can only configure an immediate MDT. The RV QoE may be optional. Parameters of the RV QoE may be configured. RV QoE can be short for RAN visible QoE. This is a kind of sub-function.

Table 14 shows key points for step 3.

TABLE 14

| | | | IE type and | |
|---|---|---|---|---|
| IE/Group Name | Presence | Range | reference | Semantics description |
| CHOICE Area | M | | | |
| Scope of QMC | | | | |
| >Cell based | | | | |
| >>Cell ID List | | 1 . . . | | |
| for QMC | | <maxnoofCellIDforQMC> | | |
| >>>NG-RAN CGI | M | | | |
| >TAI based | | | | |
| >>TAI List for | | 1 . . . | | |
| QMC | | <maxnoofTAforQMC> | | |
| >>>TAI | M | | | |
| Slice Support List | | 0 . . . 1 | | |
| for QMC | | | | |
| >Slice Support | | 1 . . . | | |
| QMC Item | | <maxnoofSNSSAIforQMC> | | |
| >>S-NSSAI | M | | | |
| CHOICE MDT | O | | | Indicates the MDT |
| Alignment | | | | measurements with which |
| Information | | | | alignment is required. |
| >S-based MDT | | | | |
| >>NG-RAN | M | | OCTET | This information element |
| Trace ID | | | STRING | (IE) can comprise Trace |
| | | | | Reference, and Trace |
| | | | | Recording Session |
| | | | | Reference. |
| Available RAN | O | | | |
| Visible QoE | | | | |
| Metrics | | | | |

### Implementation Example 10-Non-Connected Only Logged QoE Other QoE Config Configuration

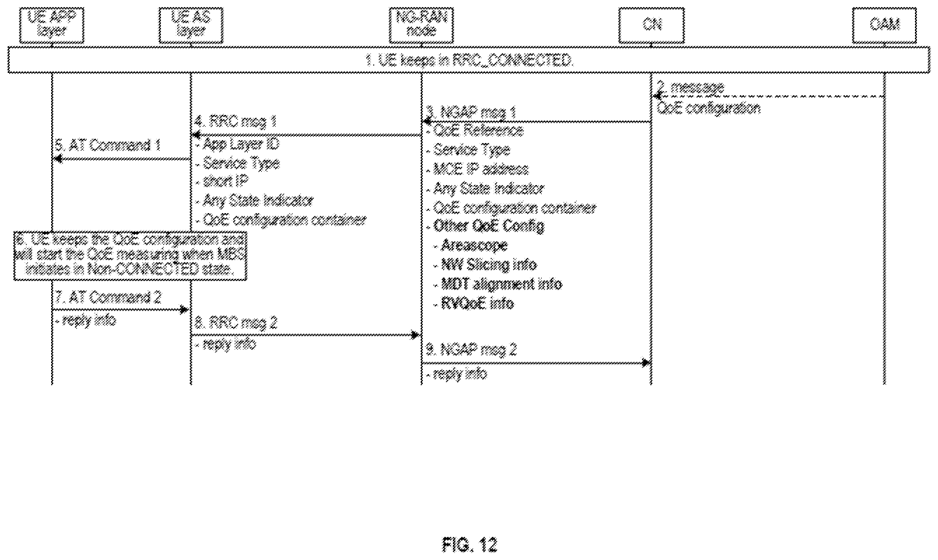

FIG. 12 is a sequence diagram illustrating a procedure for a logged QoE, in accordance with some embodiments. The procedure may be perform by a UE application (APP) layer, a UE access stratum (AS) layer, a next generation radio access network (NG-RAN) node, a core network (CN), and an operations and maintenance (OAM). It is noted that the procedure is merely an example, and is not intended to limit the present disclosure. Accordingly, it is understood that additional operations (e.g., blocks) may be provided before, during, and after the procedure of FIG. 12, certain operations may be omitted, certain operations may be performed concurrently with other operations, and that some other operations may be briefly described herein.

In step 3, a CN may send a NG application protocol (AP) message 1 to a NG-RAN node within a logged QoE configuration message. The NGAP message 1 may include at least one of the following information: a QoE reference; a service type; a state indicator (any state indicator); a Measurement Collector Entity (MCE) IP address; or a QoE configuration container. In certain embodiments, the NGAP message 1 may further include at least one of the following information: an area scope associated with the QoE; network (NW) slicing information associated with the QoE; Minimization of Driving Test (MDT) alignment information associated with the QoE; or Radio Access Network Visible (RV) QoE. The area scope may be an optional parameter. If the area scope is configured, the value may be “void” (e.g., indicating a parameter is configured without value or null value), or a subset of the MBS service area (e.g., the area scope of the logged QoE may not be larger than the MBS service area). The NW slicing information may be an optional parameter. A value of the NW slicing information can be void (e.g., indicating a parameter is configured without value or null value), as same as a MBS NW slicing information or NW slicing information other than MBS's. The MDT alignment information may be optional. The NW can only configure a logged MDT. The RV QoE may be optional. In some embodiments, the RV QoE may be performed in non-CONNECTED states. Parameters of the RV QoE may be configured.

A time stamp can be contained in each QoE report. When a NW receives the logged QoE reports and the logged MDT reports, the NW may check the time stamp in the logged QoE report and may align the logged QoE report to the related logged MDT report which may have same or related time stamp. The alignment work may be completed by a NG-RAN node, a CN, an OAM, or a multimedia broadcast multicast service coordination entity (MCE).

Table 15 shows key points for step 3.

TABLE 15

| | | | IE type and | |
|---|---|---|---|---|
| IE/Group Name | Presence | Range | reference | Semantics description |
| CHOICE Area | M | | | |
| Scope of QMC | | | | |
| >Cell based | | | | |
| >>Cell ID List | | 1 . . . | | |
| for QMC | | <maxnoofCellIDforQMC> | | |
| >>>NG-RAN | M | | | |
| CGI | | | | |
| >TAI based | | | | |
| >>TAI List for | | 1 . . . | | |
| QMC | | <maxnoofTAforQMC> | | |
| >>>TAI | M | | | |
| Slice Support List | | 0 . . . 1 | | |
| for QMC | | | | |
| >Slice Support | | 1 . . . | | |
| QMC Item | | <maxnoofSNSSAIforQMC> | | |
| >>S-NSSAI | M | | | |
| MDT Alignment | | | | Indicates the MDT |
| Information | | | | measurements with which |
| | | | | alignment is required. |
| >M-based MDT | | | | |
| >>NG-RAN | | | OCTET | This information element |
| Trace ID | | | STRING | (IE) can comprise Trace |
| | | | | Reference and Trace |
| | | | | Recording Session |
| | | | | Reference. |
| Available RAN | O | | | |
| Visible QoE | | | | |
| Metrics | | | | |

### Implementation Example 11-Any RRC State Logged QoE Other QoE Config Parameters

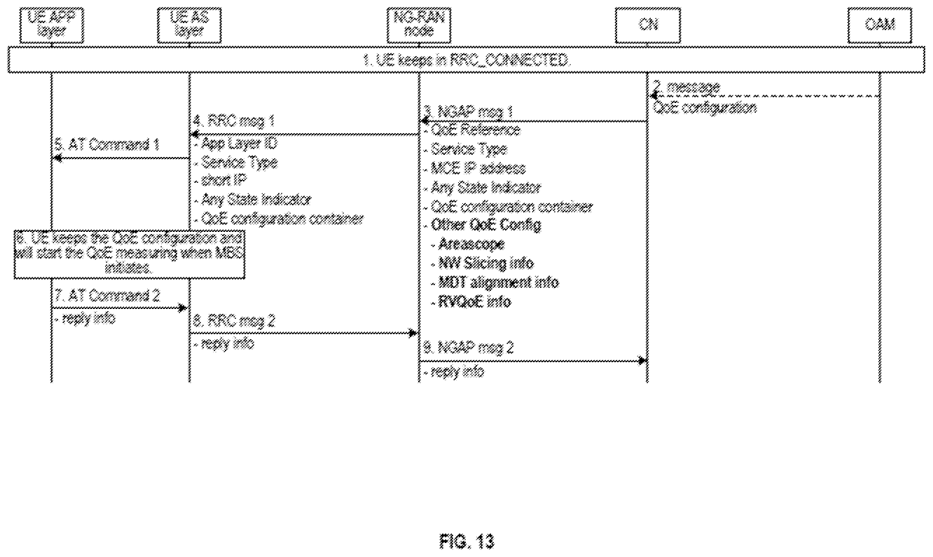

FIG. 13 is a sequence diagram illustrating a procedure for a logged QoE, in accordance with some embodiments. The procedure may be perform by a UE application (APP) layer, a UE access stratum (AS) layer, a next generation radio access network (NG-RAN) node, a core network (CN), and an operations and maintenance (OAM). It is noted that the procedure is merely an example, and is not intended to limit the present disclosure. Accordingly, it is understood that additional operations (e.g., blocks) may be provided before, during, and after the procedure of FIG. 13, certain operations may be omitted, certain operations may be performed concurrently with other operations, and that some other operations may be briefly described herein.

In step 3, a CN may send a NG application protocol (AP) message 1 to a NG-RAN node within a logged QoE configuration message. The NGAP message 1 may include at least one of the following information: a QoE reference; a service type; a state indicator (any state indicator); a Measurement Collector Entity (MCE) IP address; or a QoE configuration container. In certain embodiments, the NGAP message 1 may further include at least one of the following information: an area scope associated with the QoE; network (NW) slicing information associated with the QoE; Minimization of Driving Test (MDT) alignment information associated with the QoE; or Radio Access Network Visible (RV) QoE. The area scope may be an optional parameter. If the area scope is configured, the value may be “void” (e.g., indicating a parameter is configured without value or null value), or a subset of the MBS service area (e.g., the area scope of the logged QoE may not be larger than the MBS service area). The NW slicing information may be an optional parameter. A value of the NW slicing information can be void (e.g., indicating a parameter is configured without value or null value), as same as a MBS NW slicing information or NW slicing information other than MBS's. The MDT alignment information may be optional. The logged MDT and/or immediate MDT can be configured. The RV QoE may be optional. In some embodiments, the RV QoE may be performed in non-CONNECTED states. Parameters of the RV QoE may be configured.

A time stamp can be contained in each QoE report. When a NW receives the logged QoE reports and the logged MDT reports, the NW may check the time stamp in the logged QoE report and may align the logged QoE report to the related logged MDT report which may have same or related time stamp.

Table 16 shows key points for step 3.

TABLE 16

| | | | IE type and | |
|---|---|---|---|---|
| IE/Group Name | Presence | Range | reference | Semantics description |
| CHOICE Area | M | | | |
| Scope of QMC | | | | |
| >Cell based | | | | |
| >>Cell ID List | | 1 . . . | | |
| for QMC | | <maxnoofCellIDforQMC> | | |
| >>>NG-RAN | M | | | |
| CGI | | | | |
| >TAI based | | | | |
| >>TAI List for | | 1 . . . | | |
| QMC | | <maxnoofTAforQMC> | | |
| >>>TAI | M | | | |
| Slice Support List | | 0 . . . 1 | | |
| for QMC | | | | |
| >Slice Support | | 1 . . . | | |
| QMC Item | | <maxnoofSNSSAIforQMC> | | |
| >>S-NSSAI | M | | | |
| MDT Alignment | | | | Indicates the MDT |
| Information | | | | measurements with which |
| | | | | alignment is required. |
| >M-based MDT | O | | | |
| >>NG-RAN | | | OCTET | This information element |
| Trace ID | | | STRING | (IE) can comprise Trace |
| | | | | Reference and Trace |
| | | | | Recording Session |
| | | | | Reference. |
| >S-based MDT | O | | | |
| >>NG-RAN | | | OCTET | This information element |
| Trace ID | | | STRING | (IE) can comprise Trace |
| | | | | Reference and Trace |
| | | | | Recording Session |
| | | | | Reference. |
| Available RAN | O | | | |
| Visible QoE | | | | |
| Metrics | | | | |

### Implementation Example 12-CONNECTED Logged QoE Reporting

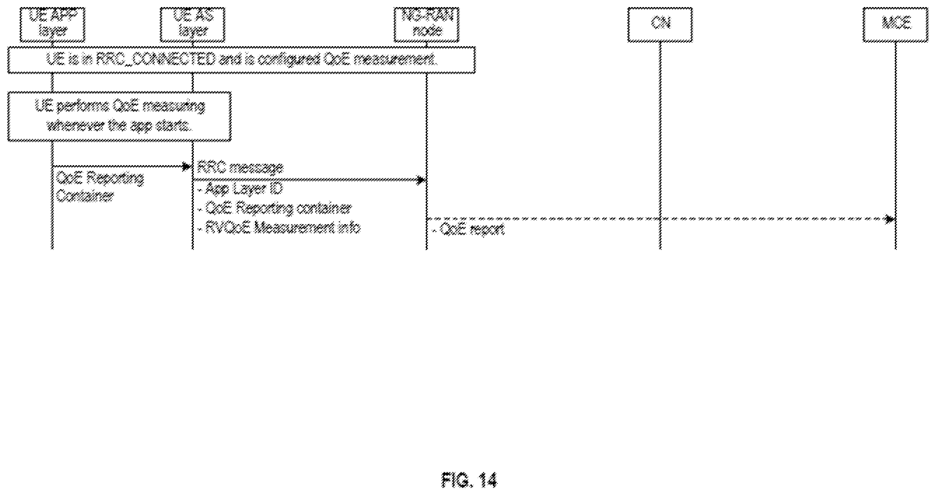

FIG. 14 is a sequence diagram illustrating a procedure for a logged QoE, in accordance with some embodiments. The procedure may be perform by a UE application (APP) layer, a UE access stratum (AS) layer, a next generation radio access network (NG-RAN) node, a core network (CN), and a Measurement Collector Entity (MCE). It is noted that the procedure is merely an example, and is not intended to limit the present disclosure. Accordingly, it is understood that additional operations (e.g., blocks) may be provided before, during, and after the procedure of FIG. 14, certain operations may be omitted, certain operations may be performed concurrently with other operations, and that some other operations may be briefly described herein. In this implementation example, a logged QoE can only perform/work/trigger in RRC_CONNECTED state.

Referring now to FIG. 14, the procedure/call flow may be only for CONNECTED logged QoE reporting. The logged QoE reporting may be a procedure to upload QoE reports.

For implementation examples 13-15, logged reporting may or may not be one of the reason to trigger RRC states changing. Specifically, a UE may trigger a RRC state changing (e.g., from RRC non-CONNECTED to CONNECTED) because the logged QoE may need to report buffered data. In some embodiments, the logged QoE reporting may not be the only reason to trigger a RRC state changing in any scenario.

### Implementation Example 13-INACTIVE Logged QoE Reporting (for Non-CONNECTED and any RRC State Logged QoE)

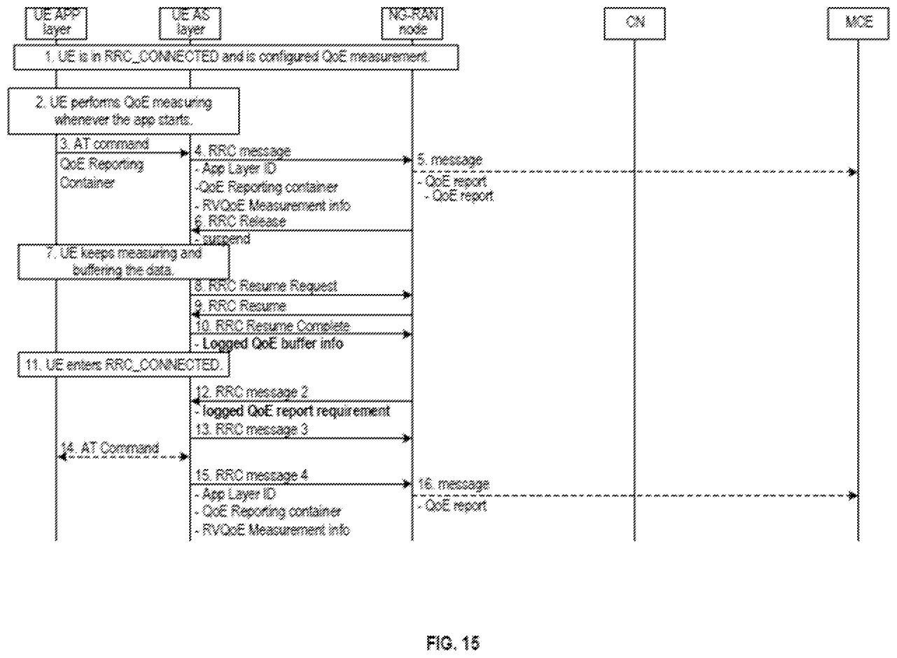

FIG. 15 is a sequence diagram illustrating a procedure for a logged QoE, in accordance with some embodiments. The procedure may be perform by a UE application (APP) layer, a UE access stratum (AS) layer, a next generation radio access network (NG-RAN) node, a core network (CN), and a Measurement Collector Entity (MCE). It is noted that the procedure is merely an example, and is not intended to limit the present disclosure. Accordingly, it is understood that additional operations (e.g., blocks) may be provided before, during, and after the procedure of FIG. 15, certain operations may be omitted, certain operations may be performed concurrently with other operations, and that some other operations may be briefly described herein.

In step 1, a UE may be in an RRC_CONNECTED state. The UE can be configured to non-CONNECTED for a logged QoE or any RRC state logged QoE. The logged QoE configuration may trigger a QoE reporting behavior in any RRC status/state. The UE can transmit QoE reports to the network when the UE enters RRC_CONNECTED state.

In step 2 (conditional), if a MBS initiates when the UE is in RRC_CONNECTED for any RRC state logged QoE, the logged QoE may be activated. The UE may start to record logged QoE data.

In step 3 (conditional), for any RRC state logged QoE, a UE APP layer may upload a QoE report to a UE AS layer.

In step 4 (conditional), for any RRC state logged QoE, a UE AS layer may send QoE reporting information to a NG-RAN node via a RRC message. The RRC message may include at least one of the following information: an application (APP) layer identifier (ID); a QoE reporting container; or Radio Access Network Visible (RV) QoE measurement information. The APP layer ID can be used/utilized/applied to mark the logged QoE between the UE and a NG-RAN node.

In step 5 (conditional), the NG-RAN node may send the QoE report to a Measurement Collector Entity (MCE). There may be no need to be standardized. Step 2-5 may occur when any RRC state logged QoE is configured to the UE.

In step 6, the NG-RAN may send a RRC release message (a second message) to the UE.

In step 7, when the UE receives the RRC release message with a suspend indicator, the UE may switch to a RRC_INACTIVE state. For any state logged QoE, the UE can keep measuring and can keep new generated QoE data into a buffer at the UE side. For non-CONNECTED logged QoE, a logged QoE may not be activated when UE is in RRC_CONNECTED state. After the UE switches to RRC_INACTIVE state, the UE may perform the logged QoE and may record QoE data into a buffer at the UE side if the MBS starts.

In step 8, when the UE keeps/continues in RRC_INACTIVE state, the UE can send a RRC resume request message to switch the UE to RRC_CONNECTED state. Before the UE sends the RRC resume request message, the UE may have recorded some QoE reports in a local buffer. The logged QoE buffer may not be empty, which may not be the reason (or the only reason) that the UE can switch to RRC_CONNECTED state.

In step 9, when the NG-RAN node receives the RRC resume request message, the NG-RAN may reply a RRC resume message (a fifth message).

In step 10, when the UE receives the RRC resume message, the UE may reply a RRC resume complete message (a sixth message) and may complete the RRC resume procedure. In some embodiments, the RRC resume message may cause the UE to switch back into a RRC_CONNECTED state. Information (e.g., QoE buffer information) about logged QoE buffered data may be added into the RRC resume complete message. The QoE buffer information may indicate attributes of the QoE buffer. In certain embodiments, the QoE buffer information may not include any measured data. The QoE buffer information may be a constant value after configuration. For example, specific buffer information may include at least one of following: a buffer size, a buffer period, a QoE reference ID, or how to handle the buffer overflow. The buffer size may indicate place that can hold the buffer. The RRC resume complete message may include at least one of the following information: 1-bit indicator; or detail information about the logged QoE and/or QoE buffer. The 1-bit indicator can show the logged QoE buffer may not be empty. For each involved logged QoE, the 1-bit indicator can show the logged QoE buffer may not be empty. The detail information about the logged QoE may include QoE session information, a number of QoE reports, a QoE report size, or other QoE parameters related data. The detail information about the QoE buffer may include a buffer size, whether a buffer is full, or a UE buffer setup (e.g., AS layer buffer or APP layer buffer). In some embodiments, the RRC resume complete message (the sixth message) may not contain any QoE buffered data. The RRC resume complete message may include information or status description about the logged QoE. In some embodiments, the QoE buffered data can be buffered data. The data can be stored in a QoE buffer by the UE. The data in the QoE buffer can be generated by a QoE measuring. All the data can be a monitoring/recording of configured QoE parameters (e.g., information about playlist, buffer level, and/or video delay). In some embodiments, the UE may store the QoE buffered data when the US is not in an RRC_CONNECTED state.

In step 11, the UE may enter a RRC_CONNECTED state. For a non-CONNECTED logged QoE, the UE may stop an ongoing logged QoE measuring. In some embodiments, the UE may not activate a new logged QoE, but the ongoing one can be continued. For any state logged QoE, the UE can keep measuring and reporting (e.g., step 2 to step 5).

In step 12 (alternative), after the NG-RAN node receives the logged buffer QoE information from the UE, the NG-RAN may send a RRC message with the logged QoE report requirement information to the UE. The RRC message may include at least one of the following information: an application (APP) layer identifier (ID); a QoE reference; or logged QoE buffer information. The APP ID may be used/utilized/applied to mark the logged QoE between the US and the NG-RAN node.

In step 13 (alternative), the UE may reply messages (e.g., RRC message 3) for the RRC message 2 from the NG-RAN node. In some embodiments, ACK information may be contained in the reply messages. The reply messages may be without any logged QoE information if everything works normally. Step 12 and step 13 can be another alternative for logged QoE data reporting. The NG-RAN node can require the UE to upload the buffered data when the NG-RAN node receives the related information from the UE side at step 10. In certain embodiments, the UE can transmit the buffered logged QoE data directly without NG-RAN node requirements. In the alternative, step 12 and step 13 may be not needed.

In step 14, an ATtention (AT) command may be transmitted between the UE AS layer and the UE APP layer for QoE reporting.

In step 15, the US may send QoE buffered data to the NG-RAN node via RRC message 2.

In step 16, the NG-RAN node may forward the received logged QoE data to a Measurement Collector Entity (MCE).

### Implementation Example 14-IDLE Logged QoE Reporting without QoE Configuration Retrieve (for Non-CONNECTED Logged QoE)

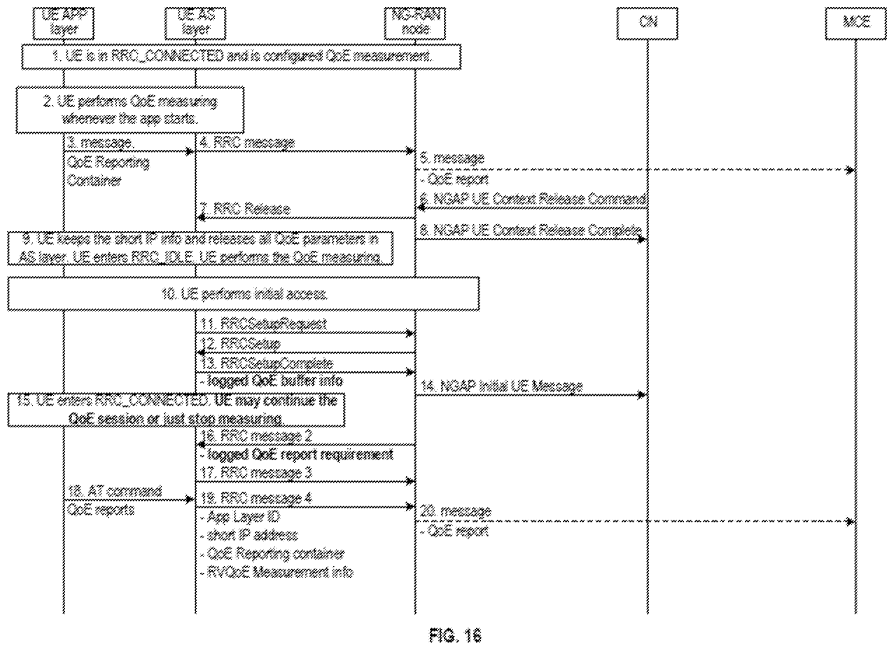

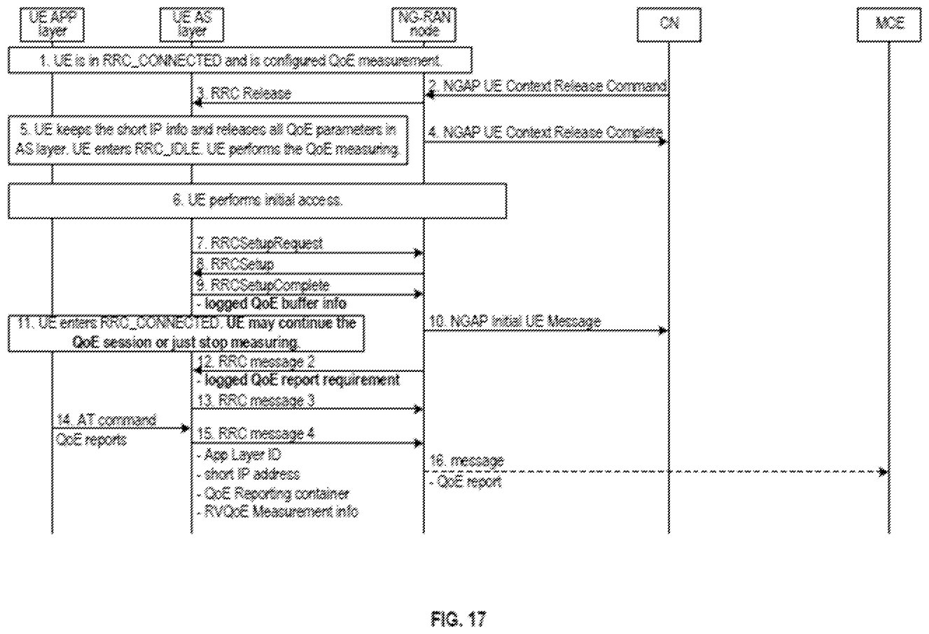

FIGS. 16 and 17 show a sequence diagram illustrating a procedure for a logged QoE, in accordance with some embodiments. The procedure may be perform by a UE application (APP) layer, a UE access stratum (AS) layer, a next generation radio access network (NG-RAN) node, a core network (CN), and a Measurement Collector Entity (MCE). It is noted that the procedure is merely an example, and is not intended to limit the present disclosure. Accordingly, it is understood that additional operations (e.g., blocks) may be provided before, during, and after the procedure of FIGS. 16 and 17, certain operations may be omitted, certain operations may be performed concurrently with other operations, and that some other operations may be briefly described herein.

In step 1, a UE may be in an RRC_CONNECTED state. The UE can be configured to non-CONNECTED for a logged QoE. The logged QoE configuration may trigger a QoE reporting behavior in any RRC status/state. The UE can transmit QoE reports to the network when the UE enters RRC_CONNECTED state.

In step 2 (conditional), if a MBS initiates when the UE is in RRC_CONNECTED for any RRC state logged QoE, the logged QoE may be activated. The UE may start to record logged QoE data.

In step 3 (conditional), for any RRC state logged QoE, a UE APP layer may upload a QoE report to a UE AS layer.

In step 4 (conditional), for any RRC state logged QoE, a UE AS layer may send QoE reporting information to a NG-RAN node via a RRC message. The RRC message may include at least one of the following information: an application (APP) layer identifier (ID); a QoE reporting container; or Radio Access Network Visible (RV) QoE measurement information. The APP layer ID can be used/utilized/applied to mark the logged QoE between the UE and a NG-RAN node.

In step 5 (conditional), the NG-RAN node may send the QoE report to a Measurement Collector Entity (MCE). There may be no need to be standardized. Step 2-5 may occur when any RRC state logged QoE is configured to the UE.

In step 6, 7, and 8, the system may perform a RRC release procedure. The UE can switch to a RRC_IDLE state.

In step 9, before the UE releases all UE context and switches to the RRC_IDLE state, the UE may keep short IP information and configuration at the UE side. When the UE enters RRC_IDLE state, the UE can perform a logged QoE measurement if MBS starts.

In step 10, the UE may decide to switch to RRC_CONNECTED state and may perform an initial access procedure. The logged QoE buffer may not be empty, which may not be the reason (or the only reason) that the UE can switch to RRC_CONNECTED state.

In step 11, the UE may send a RRC setup request message to a NG-RAN node.

In step 12, the NG-RAN node may send a RRC setup message to the UE.

In step 13, the UE may send a RRC setup complete message to the NG-RAN node. Information (e.g., QoE buffer information) about logged QoE buffered data may be added into the RRC setup complete message. The QoE buffer information may indicate attributes of the QoE buffer. In certain embodiments, the QoE buffer information may not include any measured data. The QoE buffer information may be a constant value after configuration. For example, specific buffer information may include at least one of following: a buffer size, a buffer period, a QoE reference ID, or how to handle the buffer overflow. The buffer size may indicate place that can hold the buffer. The RRC resume complete message may include at least one of the following information: a 1-bit indicator indicating that a buffer of the UE may not be empty; QoE session information; a number of QoE reports; a QoE report size for one QoE session; data on other QoE parameters related data; a size of the buffer; a QoE reference ID for the logged QoE; or detail information about the logged QoE and/or QoE buffer. For each involved logged QoE session, the detail information about the logged QoE may include QoE session information, a number of QoE reports, a QoE report size, or other QoE parameters related data. The detail information about the QoE buffer may include a buffer size, whether a buffer is full, or a UE buffer setup (e.g., AS layer buffer or APP layer buffer). The RRC resume complete message may include information or status description about the logged QoE. In some embodiments, the RRC resume message may cause the UE to switch back into a RRC_CONNECTED state. In some embodiments, the QoE buffered data can be buffered data. The data can be stored in a QoE buffer by the UE. The data in the QoE buffer can be generated by a QoE measuring. All the data can be a monitoring/recording of configured QoE parameters (e.g., information about playlist, buffer level, and/or video delay). In some embodiments, the UE may store the QoE buffered data when the US is not in an RRC_CONNECTED state.

In step 14, the NG-RAN node may send a NGAP initial UE message to the CN.

In step 15, the UE may enter RRC_CONNECTED state. At least one of the following alternatives may be selected by the UE. The UE may stop all ongoing logged QoE and may not activate a new non-CONNECTED logged QoE in RRC_CONNECTED state. Alternatively, the UE may continue perform the logged QoE measurements if the logged QoE measurements is an ongoing one, and the UE may not activate a new non-CONNECTED logged QoE in RRC_CONNECTED state.

In step 16 (alternative), after the NG-RAN node receives the logged buffer QoE information from the UE, the NG-RAN may send a RRC message with the logged QoE report requirement information to the UE. The RRC message may include at least one of the following information: an application (APP) layer identifier (ID); a QoE reference; or logged QoE buffer information. The APP ID may be used/utilized/applied to mark the logged QoE between the US and the NG-RAN node.

In step 17 (alternative), the UE may reply messages (e.g., RRC message 3) for the RRC message 2 from the NG-RAN node. In some embodiments, ACK information may be contained in the reply messages. The reply messages may be without any logged QoE information if everything works normally. Step 16 and step 17 can be another alternative for logged QoE data reporting. The NG-RAN node can require the UE to upload the buffered data when the NG-RAN node receives the related information from the UE side at step 10. In certain embodiments, the UE can transmit the buffered logged QoE data directly without NG-RAN node requirements. In the alternative, step 16 and step 17 may be not needed. In some embodiments, after the UE switches to CONNECTED state, the UE may directly upload the QoE buffered reports. Alternatively, the UE can wait for network requirement. This can be the reason why network may provide the QoE session information to the UE.

In step 18, an ATtention (AT) command may be transmitted between the UE AS layer and the UE APP layer for QoE reporting.

In step 19, the US may send the QoE buffered data to the NG-RAN node via RRC message 2.

In step 20, the NG-RAN node may forward the received logged QoE data to a Measurement Collector Entity (MCE).

### Implementation Example 15-IDLE Logged QoE Reporting without QoE Configuration Retrieval (for any RRC State and Non-CONNECTED Logged QoE)

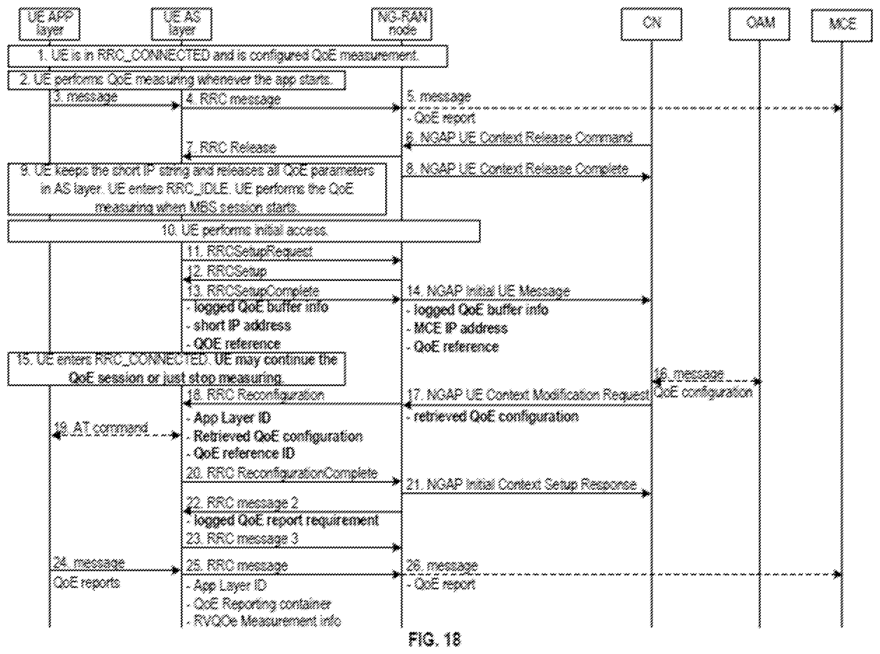

FIG. 18 is a sequence diagram illustrating a procedure for a logged QoE, in accordance with some embodiments. The procedure may be perform by a UE application (APP) layer, a UE access stratum (AS) layer, a next generation radio access network (NG-RAN) node, a core network (CN), an operations and maintenance (OAM), and a Measurement Collector Entity (MCE). It is noted that the procedure is merely an example, and is not intended to limit the present disclosure. Accordingly, it is understood that additional operations (e.g., blocks) may be provided before, during, and after the procedure of FIG. 18, certain operations may be omitted, certain operations may be performed concurrently with other operations, and that some other operations may be briefly described herein.

In step 1, a UE may be in an RRC_CONNECTED state. The UE can be configured to non-CONNECTED for a logged QoE or any RRC state logged QoE. The logged QoE configuration may trigger a QoE reporting behavior in any RRC status/state. The UE can transmit QoE reports to the network when the UE enters RRC_CONNECTED state.

In step 2 (conditional), if a MBS initiates when the UE is in RRC_CONNECTED for any RRC state logged QoE, the logged QoE may be activated. The UE may start to record logged QoE data.

In step 3 (conditional), for any RRC state logged QoE, a UE APP layer may upload a QoE report to a UE AS layer.

In step 4 (conditional), for any RRC state logged QoE, a UE AS layer may send QoE reporting information to a NG-RAN node via a RRC message. The RRC message may include at least one of the following information: an application (APP) layer identifier (ID); a QoE reporting container; or Radio Access Network Visible (RV) QoE measurement information. The APP layer ID can be used/utilized/applied to mark the logged QoE between the UE and a NG-RAN node.

In step 5 (conditional), the NG-RAN node may send the QoE report to a Measurement Collector Entity (MCE). Step 2-5 may occur when any RRC state logged QoE is configured to the UE.

In step 6, 7, and 8, the system may perform a RRC release procedure. The UE can switch to a RRC_IDLE state.

In step 9, before the UE releases all UE context and switches to the RRC_IDLE state, the UE may keep short IP information and configuration at the UE side. When the UE enters RRC_IDLE state, the UE can continue an ongoing logged QoE and can activate a new logged QoE for any RRC state logged QoE. In some embodiments, when the UE enters RRC_IDLE state, the UE can activate the logged QoE measurements if MBS starts for a non-CONNECTED logged QoE. The new generated logged QoE data may be kept in a buffer at the UE side. The logged QoE buffer may not be empty, which may not be the reason (or the only reason) that the UE can switch to RRC_CONNECTED state.

In step 10, the UE may decide/determine to switch to RRC_CONNECTED state, and may perform an initial access procedure.

In step 11, the UE may send a RRC setup request message to the NG-RAN node.

In step 12, the NG-RAN node may send a RRC setup message to the UE.

In step 13, the UE may send a RRC setup complete message to the NG-RAN node. Information (e.g., QoE buffer information) about logged QoE buffered data may be added into the RRC setup complete message. The QoE buffer information may indicate attributes of the QoE buffer. In certain embodiments, the QoE buffer information may not include any measured data. The QoE buffer information may be a constant value after configuration. For example, specific buffer information may include at least one of following: a buffer size, a buffer period, a QoE reference ID, or how to handle the buffer overflow. The buffer size may indicate place that can hold the buffer. The RRC resume complete message may include at least one of the following information: 1-bit indicator; a QoE reference ID for the logged QoE; or detail information about the logged QoE and/or QoE buffer. For each involved logged QoE session, the detail information about the logged QoE may include QoE session information, a number of QoE reports, a QoE report size, or other QoE parameters related data. The detail information about the QoE buffer may include a buffer size, whether a buffer is full, or a UE buffer setup (e.g., AS layer buffer or APP layer buffer). The RRC resume complete message may include information or status description about the logged QoE. In some embodiments, the QoE buffered data can be buffered data. The data can be stored in a QoE buffer by the UE. The data in the QoE buffer can be generated by a QoE measuring. All the data can be a monitoring/recording of configured QoE parameters (e.g., information about playlist, buffer level, and/or video delay). In some embodiments, the UE may store the QoE buffered data when the US is not in an RRC_CONNECTED state.

In step 14, the NG-RAN node may send a NGAP message (e.g., initial UE message) to the CN with the received logged QoE information. The NGAP message may include at least one of the following information: a QoE reference; a Measurement Collector Entity (MCE) information; 1-bit indicator; or detail information about the logged QoE and/or QoE buffer. The NG-RAN node can get an IP address by receiving short IP information. The 1-bit indicator can show that the logged QoE may not be empty. For each involved logged QoE session, the detail information about the logged QoE may include QoE session information, a number of QoE reports, a QoE report size, or other QoE parameters related data. The detail information about the QoE buffer may include a buffer size, whether a buffer is full, or a UE buffer setup (e.g., AS layer buffer or APP layer buffer).

In step 15, the UE may enter RRC_CONNECTED state. For any RRC state logged QoE, the UE may keep running and may be activated. At least one of the following alternatives may be selected by the UE for the non-CONNECTED logged QoE. The UE may stop all ongoing logged QoE and may not activate a new non-CONNECTED logged QoE in RRC_CONNECTED state. Alternatively, the UE may continue perform the logged QoE measurements if the logged QoE measurements is an ongoing one, and the UE may not activate a new non-CONNECTED logged QoE in a RRC_CONNECTED state.

In step 16, the CN may exchange the received logged QoE information with an OAM. The OAM may send the retrieved logged QoE configuration to the CN.

In step 17, the CN may send a NGAP message (e.g., UE context modification request) to the NG-RAN node with the retrieved logged QoE configuration. The information contained in the NGAP message may depend on what system selected and other QoE parameters configuration described in previous implementation examples.

In step 18, the NG-RAN node may send a RRC message (e.g., RRC reconfiguration) to the UE AS layer. The RRC message may include at least one of the following information: an application (APP) layer identifier (ID); retrieved logged QoE configuration; or a QoE reference ID.

In step 19, the UE AS layer may exchange messages with the UE APP layer on the received logged QoE configuration.

In step 20, the UE may reply a RRC message (e.g., RRC reconfiguration) to the NG-RAN node.

In step 21, the NG-RAN node may send a NGAP message (e.g., NGAP initial context setup response) to the CN.

In step 22 (alternative), after the NG-RAN node receives the logged QoE buffer information, the NG-RAN node may send a RRC message with the logged QoE report requirement information. The RRC message may include at least one of the following information: an application (APP) layer identifier (ID); a QoE reference; or logged QoE buffer information. The APP ID may be used/utilized/applied to mark the logged QoE between the US and the NG-RAN node.

In step 23 (alternative), the UE may reply messages (e.g., RRC message 3) for the RRC message 2 from the NG-RAN node. In some embodiments, ACK information may be contained in the reply messages. The reply messages may be without any logged QoE information if everything works normally. Step 22 and step 23 can be another alternative for logged QoE data reporting. The NG-RAN node can require the UE to upload the buffered data when the NG-RAN node receives the related information from the UE side at step 10. In certain embodiments, the UE can transmit the buffered logged QoE data directly without NG-RAN node requirements. Step 22 and step 23 may be another way for logged QoE data reporting. The NG-RAN node can require the UE to upload buffered data when the UE receives related information from the UE side at step 10. The UE can also transmit the buffered logged QoE data directly without a NG-RAN node requirement. In the alternative, step 22 and step 23 may be not needed. In some embodiments, after the UE switches to CONNECTED state, the UE may directly upload the QoE buffered reports. Alternatively, the UE can wait for network requirement. This can be the reason why network may provide the QoE session information to the UE.

Step 24, step 25, and/or step 26 may be QoE reporting procedure(s).

Table 17 shows key points for step 14 with one indicator for all logged QoE sessions.

TABLE 17

| | | | | |
|---|---|---|---|---|
| | | | IE type and | |
| IE/Group Name | Presence | Range | reference | Semantics description |

| | | | |
|---|---|---|---|
| QoE Reference | M | OCTET STRING | QoE Reference may comprise |
| | | (SIZE(6)) | mobile country code (MCC), |
| | | | mobile network code (MNC), |
| | | | and QoE measurement |
| | | | collection (QMC) ID. The |
| | | | MCC and MNC can be with |
| | | | trace activation request from |
| | | | a management system to |
| | | | identify one public land |
| | | | mobile network (PLMN) |
| | | | containing the management |
| | | | system. The QMC ID can be |
| | | | a 3-bytes Octet String. |
| Measurement | M | Transport Layer | The IP address of the entity |
| Collection Entity | | Address | receiving the QoE |
| IP Address | | | measurement report. |
| Logged QoE | O | ENUMERATED | This information element (IE) |
| Buffer Indicator | | (True, . . . ) | can indicate the logged QoE |
| | | | buffer may not be empty. |

Table 18 shows key points when each logged QoE has an indicator and information.

TABLE 18

| | | | | |
|---|---|---|---|---|
| | | | IE type and | |
| IE/Group Name | Presence | Range | reference | Semantics description |

| | | | |
|---|---|---|---|
| Logged QoE Buffer | | | |
| Info List | | | |
| >Logged QoE Buffer | | | |
| Item | | | |
| >>QoE Reference | M | OCTET STRING | QoE Reference may comprise |
| | | (SIZE(6)) | mobile country code (MCC), |
| | | | mobile network code (MNC), |
| | | | and QoE measurement |
| | | | collection (QMC) ID. The |
| | | | MCC and MNC can be with |
| | | | trace activation request from |
| | | | a management system to |
| | | | identify one public land |
| | | | mobile network (PLMN) |
| | | | containing the management |
| | | | system. The QMC ID can be |
| | | | a 3-bytes Octet String. |
| >>Logged QoE | O | ENUMERATED | This information element (IE) |
| Buffer Indicator | | (True, . . . ) | may indicate the logged QoE |
| | | | buffer for this logged QoE |
| | | | session may not be empty. |
| >> Detail Buffer Info | O | | |
| >>> number of | O | INTEGER (1 . . . 4095, | |
| QoE reports | | . . . )(or other | |
| | | max value) | |
| >>> Buffer size | O | Buffer | |
| | | size(SIZE(X . . . | |
| | | Y, . . . )) | |
| >>> Buffer | O | ENUMERATED | |
| Full Indicator | | (True, . . . ) | |
| >>> AS Layer | O | ENUMERATED | |
| Buffer Indicator | | (True, . . . ) | |
| >>> Buffered | O | Bit String(X) | |
| RVQoE Info | | | |

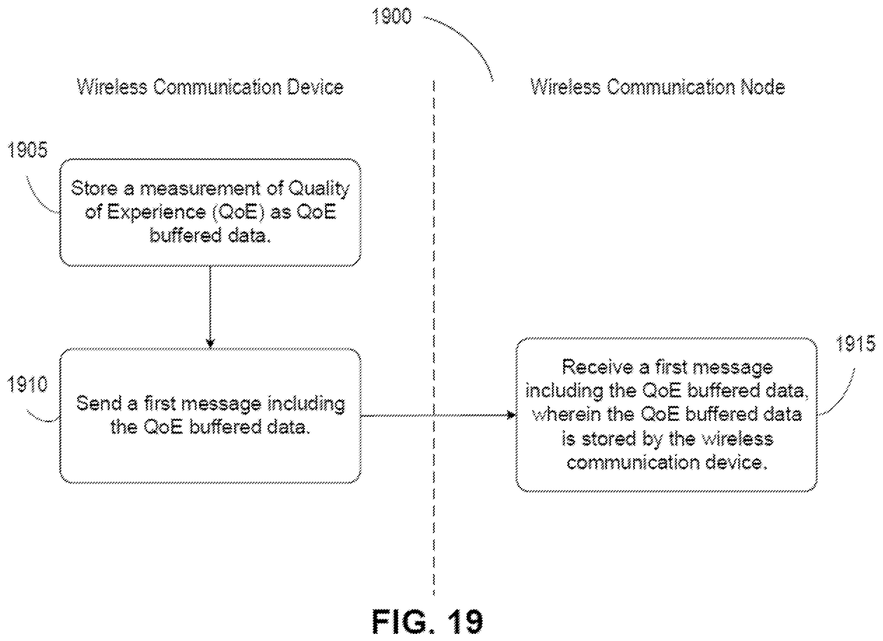

FIG. 19 illustrates a flow diagram of a method 1900 for logged QoE measurement. The method 1900 may be implemented using any one or more of the components and devices detailed herein in conjunction with FIGS. 1-2. In overview, the method 1900 may be performed by a wireless communication device (e.g., a UE) and/or a wireless communication node (e.g., a BS/RAN node), in some embodiments. Additional, fewer, or different operations may be performed in the method 1900 depending on the embodiment. At least one aspect of the operations is directed to a system, method, apparatus, or a computer-readable medium.

A wireless communication device (e.g., a UE) may store a measurement of Quality of Experience (QoE) as QoE buffered data. The wireless communication device may send a first message including the QoE buffered data to a wireless communication node (e.g., a BS).

In some embodiments, the wireless communication device may store the QoE buffered data when the wireless communication device is not in an RRC_CONNECTED state. The wireless communication device may send the first message before the wireless communication device switches back into the RRC_CONNECTED state.

In some embodiments, the wireless communication device may receive a second message (e.g., RRC release message), causing the wireless communication device to switch from an RRC_CONNECTED state to an RRC_INACTIVE state or an RRC_IDLE state, from the wireless communication node. Prior to receiving the second message, the wireless communication device may receive a third message indicating that the wireless communication device can trigger the measurement of QoE in any of the RRC_CONNECTED state, the RRC_INACTIVE state, or the RRC_IDLE state. After switching into the RRC_INACTIVE state or the RRC_IDLE state, the wireless communication device may continue storing the measurement of QoE as the QoE buffered data. In some embodiments, prior to receiving the second message, the wireless communication device may receive a fourth message indicating that the wireless communication device can only trigger the measurement of QoE in the RRC_INACTIVE state or the RRC_IDLE state. After switching into the RRC_INACTIVE state or the RRC_IDLE state, the wireless communication device may store the measurement of QoE as the QoE buffered data.

In some embodiments, the wireless communication device may receive a fifth message (e.g., RRC resume message, RRC setup message), causing the wireless communication device to switch back into the RRC_CONNECTED state, from the wireless communication node. The wireless communication device may send a sixth message (e.g., RRC resume complete message, RRC setup complete message) including QoE buffer information, in response to receiving the fifth message, to the wireless communication node. The QoE buffer information of the sixth message may include at least one of: a 1-bit indicator indicating that a buffer of the wireless communication device may not be empty; QoE session information; a number of QoE reports; a QoE report size for one QoE session; data on other QoE parameters related data; or a size of the buffer.

In some embodiments, following sending the sixth message, the wireless communication device may switch itself to the RRC_CONNECTED state. The wireless communication device may receive a seventh message (e.g., RRC message 2, RRC reconfiguration message) including QoE requirement information from the wireless communication node. The QoE requirement information may include at least one of: an APP layer identifier (ID); QoE buffer information; or a QoE reference ID. In response to receiving the seventh message, the wireless communication device may send an eighth message (e.g., RRC message 3) including acknowledgement information to the wireless communication node.

In some embodiments, a wireless communication node (e.g., a BS) may receive a first message including Quality of Experience (QoE) buffered data from a wireless communication device (e.g., a UE). The QoE buffered data may be stored by the wireless communication device.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A wireless communication method comprising:
storing, by a wireless communication device, a measurement of Quality of Experience (QoE) as QoE buffered data; and
sending, by the wireless communication device to a wireless communication node, a first message including the QoE buffered data.

2. The wireless communication method of claim 1, further comprising:
storing the QoE buffered data when the wireless communication device is not in an RRC_CONNECTED state; and
sending the first message before the wireless communication device switches back into the RRC_CONNECTED state.

3. The wireless communication method of claim 1, further comprising:
receiving, by the wireless communication device from the wireless communication node, a second message, causing the wireless communication device to switch from an RRC_CONNECTED state to an RRC_INACTIVE state or an RRC_IDLE state;
receiving, by the wireless communication device, a third message indicating that the wireless communication device can trigger the measurement of QoE in any of the RRC_CONNECTED state, the RRC_INACTIVE state, or the RRC_IDLE state; and
after switching into the RRC_INACTIVE state or the RRC_IDLE state, continuing, by the wireless communication device, storing the measurement of QoE as the QoE buffered data.

4. The wireless communication method of claim 1, further comprising:
receiving, by the wireless communication device from the wireless communication node, a second message, causing the wireless communication device to switch from an RRC_CONNECTED state to an RRC_INACTIVE state or an RRC_IDLE state;
receiving, by the wireless communication device, a fourth message indicating that the wireless communication device can only trigger the measurement of QoE in the RRC_INACTIVE state or the RRC_IDLE state; and
after switching into the RRC_INACTIVE state or the RRC_IDLE state, storing, by the wireless communication device, the measurement of QoE as the QoE buffered data.

5. The wireless communication method of claim 1, further comprising:
receiving, by the wireless communication device from the wireless communication node, a second message, causing the wireless communication device to switch from an RRC_CONNECTED state to an RRC_INACTIVE state or an RRC_IDLE state;
receiving, by the wireless communication device from the wireless communication node, a fifth message, causing the wireless communication device to switch back into the RRC_CONNECTED state; and
in response to receiving the fifth message, sending, by the wireless communication device to the wireless communication node, a sixth message including QoE buffer information.

6. The wireless communication method of claim 5, wherein the QoE buffer information of the sixth message includes at least one of: a 1-bit indicator indicating that a buffer of the wireless communication device is not empty; QoE session information; a number of QoE reports; a QoE report size for one QoE session; data on other QoE parameters related data; or a size of the buffer.

7. The wireless communication method of claim 5, further comprising:
following sending the sixth message, switching, by the wireless communication device, itself to the RRC_CONNECTED state; and
receiving, by the wireless communication device from the wireless communication node, a seventh message including QoE requirement information.

8. The wireless communication method of claim 7, wherein the QoE requirement information includes at least one of: an APP layer identifier (ID); QoE buffer information; or a QoE reference ID.

9. The wireless communication method of claim 8, further comprising:
in response to receiving the seventh message, sending, by the wireless communication device to the wireless communication node, an eighth message including acknowledgement information.

10. A wireless communication method, comprising:
receiving, by a wireless communication node from a wireless communication device, a first message including Quality of Experience (QoE) buffered data;
wherein the QoE buffered data is stored by the wireless communication device.

11. A wireless communication node, comprising:
at least one processor configured to:
receive, via a receiver a from a wireless communication device, a first message including Quality of Experience (QoE) buffered data;
wherein the QoE buffered data is stored by the wireless communication device.

12. A wireless communication device, comprising:
at least one processor configured to:
store a measurement of Quality of Experience (QoE) as QoE buffered data; and
send, via a transceiver to a wireless communication node, a first message including the QoE buffered data.

13. The wireless communication device of claim 12, wherein the at least one processor is configured to:
store the QoE buffered data when the wireless communication device is not in an RRC_CONNECTED state; and
send, via the transceiver, the first message before the wireless communication device switches back into the RRC_CONNECTED state.

14. The wireless communication device of claim 12, wherein the at least one processor is configured to:
receive, via the transceiver from the wireless communication node, a second message, causing the wireless communication device to switch from an RRC_CONNECTED state to an RRC_INACTIVE state or an RRC_IDLE state;
receive, via the transceiver, a third message indicating that the wireless communication device can trigger the measurement of QoE in any of the RRC_CONNECTED state, the RRC_INACTIVE state, or the RRC_IDLE state; and
after switching into the RRC_INACTIVE state or the RRC_IDLE state, continue to store the measurement of QoE as the QoE buffered data.

15. The wireless communication device of claim 14, wherein the at least one processor is configured to:
receive, via the transceiver from the wireless communication node, a second message, causing the wireless communication device to switch from an RRC_CONNECTED state to an RRC_INACTIVE state or an RRC_IDLE state;
receive, via the transceiver, a fourth message indicating that the wireless communication device can only trigger the measurement of QoE in the RRC_INACTIVE state or the RRC_IDLE state; and
after switching into the RRC_INACTIVE state or the RRC_IDLE state, store the measurement of QoE as the QoE buffered data.

16. The wireless communication device of claim 14, wherein the at least one processor is configured to:
receive, via the transceiver from the wireless communication node, a second message, causing the wireless communication device to switch from an RRC_CONNECTED state to an RRC_INACTIVE state or an RRC_IDLE state;
receive, via the transceiver from the wireless communication node, a fifth message, causing the wireless communication device to switch back into the RRC_CONNECTED state; and
in response to receiving the fifth message, send, via the transceiver to the wireless communication node, a sixth message including QoE buffer information.

17. The wireless communication device of claim 16, wherein the QoE buffer information of the sixth message includes at least one of: a 1-bit indicator indicating that a buffer of the wireless communication device is not empty; QoE session information; a number of QoE reports; a QoE report size for one QoE session; data on other QoE parameters related data; or a size of the buffer.

18. The wireless communication device of claim 16, wherein the at least one processor is configured to:
following sending the sixth message, switch itself to the RRC_CONNECTED state; and
receive, via the transceiver from the wireless communication node, a seventh message including QoE requirement information.

19. The wireless communication device of claim 18, wherein the QoE requirement information includes at least one of: an APP layer identifier (ID); QoE buffer information; or a QoE reference ID.

20. The wireless communication device of claim 19, wherein the at least one processor is configured to:
in response to receiving the seventh message, send, via the transceiver to the wireless communication node, an eighth message including acknowledgement information.
